(19) United States
(12) Patent Application Publication
(10) Pub. No.: US 2011/0158541 A1
(43) Pub. Date: Jun. 30, 2011

(54) IMAGE PROCESSING DEVICE, IMAGE PROCESSING METHOD AND PROGRAM

(76) Inventor: Shinji WATANABE, Tokyo (JP)

(21) Appl. No.: 12/971,904

(22) Filed: Dec. 17, 2010

(30) Foreign Application Priority Data
Dec. 25, 2009 (JP) P2009-294544

(51) Int. Cl. G06K 9/46

(52) U.S. Cl. 382/195

(57) ABSTRACT

An image processing device includes a texture extraction unit to extract a texture component of a G corrected image in which blur or defocus of a structure component of a G image including a G component of an input image is corrected, a mask generation unit to generate a mask image in which the synthesis amount of the texture component of the G corrected image to an R corrected image and a B corrected image is decreased for a region in which at least one of correlation between a variation of the G component and a variation of the R component or correlation between the variation of the G component and a variation of the B component is weak, and a synthesis unit to synthesize the texture component of the G corrected image to the R corrected image and the B corrected image using the mask image.

### BACKGROUND OF THE INVENTION

1. Field of the Invention

The present invention relates to an image processing device, an image processing method and a program and, more particularly, to an image processing device, an image processing method and a program, which is suitably used when an image in which blur or defocus occurs is corrected.

2. Description of the Related Art

In the related art, there is a correction technology of correcting hand shaking or out-of-focus (hereinafter, simply referred to as defocus) which occurs in a photographed image.

For example, there is a Richardson-Lucy method proposed by L. B. Lucy and William Hardley Richardson. However, in this method, when an inverse problem is solved using a spectrum which falls to a zero point on a frequency axis of a Point Spread Function (PSF), noise amplification, ringing generation or the like may be found at the zero point. In addition, if the PSF is not accurately obtained, noise amplification, ringing generation or the like may be more increased at the zero point.

If the PSF is accurately obtained by introduction of a gain map, there is a residual deconvolution technology capable of suppressing ringing (for example, see Lu Yuan, Jian Sun, Long Quan, Heung-Yeung Shum, Image deblurring with blurred/noisy image pairs, ACM Transactions on Graphics (TOG), v. 26 n. 3, July 2007).

However, in the residual deconvolution technology of the related art, if an error is present in the PSF, a structure component and a residual error (residual portion) of an image are not restored well and more ringing may be generated.

To this end, it is considerable that a technology (hereinafter, referred to as a structure deconvolution technology) of assembling a structure/texture separation filter for separating a structure component and a texture component of an image into a still-image hand-shaking correction algorithm based on the Richardson-Lucy method is applied.

In the structure deconvolution technology, for example, the structure component and the texture component of an image (hereinafter, referred to as a blurred image) in which blur occurs are separated by a total variation filter which is one type of structure/texture separation filter and blur is corrected with respect to only the structure component, thereby suppressing noise or ringing generation.

Here, the structure component indicates a component configuring the skeleton of an image, such as a flat portion in which an image is hardly changed, an inclined portion in which an image is slowly changed, and the contour or edge of a subject. In addition, the texture component indicates a portion configuring the details of an image, such as the detailed shape of a subject. Accordingly, most of the structure component is included in a low frequency component of a spatial frequency and most of the texture component is included in a high frequency component of the spatial frequency.

### SUMMARY OF THE INVENTION

However, in the above-described structure deconvolution technology, it is preferable that a computation amount is reduced so as to further increase a processing speed.

It is desirable to correct blur and defocus of an image at a higher speed while suppressing deterioration of image quality.

According to an embodiment of the present invention, there is provided an image processing device including: a texture extraction unit configured to extract a texture component of a G corrected image in which blur or defocus of a structure component of a G image including a G component of an input image is corrected; a mask generation unit configured to generate a mask image in which the synthesis amount of the texture component of the G corrected image to an R corrected image returning to a size before reduction after correcting blur or defocus of a structure component of an image obtained by reducing an R image including an R component of the input image and a B corrected image returning to a size before reduction after correcting blur or defocus of a structure component of an image obtained by reducing a B image including a B component of the input image is decreased for a region in which at least one of correlation between a variation of the G component of the input image and a variation of the R component of the correlation between the variation of the G component of the input image and a variation of the B component of the is weak; and a synthesis unit configured to synthesize the texture component of the G corrected image to the R corrected image and the B corrected image using the mask image.

The mask generation unit may generate a first mask image in which the synthesis amount of the texture component of the G corrected image to the R corrected image is decreased for a region in which correlation between a high frequency component of the R image and a high frequency component of the G image is weak, generate a second mask image in which the synthesis amount of the texture component of the G corrected image to the B corrected image is decreased for a region in which correlation between a high frequency component of the B image and the high frequency component of the G image is weak, the synthesize unit synthesizes the texture component of the G corrected image to the R corrected image using the first mask image, and synthesize the texture component of the G corrected image to the B corrected image using the second mask image.

The mask generation unit may include a high frequency extraction unit configured to extract high frequency components of the R image, the G image and the B image; a detection unit configured to detect a difference between the high frequency component of the R image and the high frequency component of the G image and a difference between the high frequency component of the B image and the high frequency component of the G image; and a generation unit configured to generate the first mask image in which the synthesis amount of the texture component of the G corrected image to the R corrected image is decreased for the region in which the difference between the high frequency component of the R image and the high frequency component of the G image is large and to generate the second mask image in which the synthesis amount of the texture component of the G corrected image to the B corrected image is decreased for the region in which the difference between the high frequency component of the B image and the high frequency component of the G image is large.

The image processing device may further include a reduction unit configured to reduce the R image and the B image; a correction unit configured to correct the blur or defocus of the structure component of an R reduced image obtained by reducing the R image, the structure component of a B reduced image obtained by reducing the B image, and the structure component of the G image; and an enlargement unit configured to return the R reduced image and the B reduced image after the blur or defocus is corrected to an original size.

According to another embodiment of the present invention, there is provided an information processing method including the steps of: at an image processing device, extracting a texture component of a G corrected image in which blur or defocus of a structure component of a G image including a G component of an input image is corrected; generating a mask image in which the synthesis amount of the texture component of the G corrected image to an R corrected image returning to a size before reduction after correcting blur or defocus of a structure component of an image obtained by reducing an R image including an R component of the input image and a B corrected image returning to a size before reduction after correcting blur or defocus of a structure component of an image obtained by reducing a B image including a B component of the input image is decreased for a region in which at least one of correlation between a variation of the G component of the input image and a variation of the R component of the input image or correlation between the variation of the G component of the input image and a variation of the B component of the image is weak; and synthesizing the texture component of the G corrected image to the R corrected image and the B corrected image using the mask image.

According to another embodiment of the present invention, there is provided a program for executing, on a computer, a process including the steps of: extracting a texture component of a G corrected image in which blur or defocus of a structure component of a G image including a G component of an input image is corrected; generating a mask image in which the synthesis amount of the texture component of the G corrected image to an R corrected image returning to a size before reduction after correcting blur or defocus of a structure component of an image obtained by reducing an R image including an R component of the input image and a B corrected image returning to a size before reduction after correcting blur or defocus of a structure component of an image obtained by reducing a B image including a B component of the input image is decreased for a region in which at least one of correlation between a variation of the G component of the input image and a variation of the R component of the input image or correlation between the variation of the G component of the input image and a variation of the B component of the input image is weak; and synthesizing the texture component of the G corrected image to the R corrected image and the B corrected image using the mask image.

According to one embodiment of the present invention, a texture component of a G corrected image in which blur or defocus of a structure component of a G image including a G component of an input image is corrected is extracted, a mask image in which the synthesis amount of the texture component of the G corrected image to an R corrected image returning to a size before reduction after correcting blur or defocus of a structure component of an image obtained by reducing an R image including an R component of the input image and a B corrected image returning to a size before reduction after correcting blur or defocus of a structure component of an image obtained by reducing a B image including a B component of the input image is decreased for a region in which at least one of correlation between a variation of the G component of the input image and a variation of the R component of the input image or correlation between the variation of the G component of the input image and a variation of the B component of the input image is weak is generated, and the texture component of the G corrected image is synthesized to the R corrected image and the B corrected image using the mask image.

According to one embodiment of the present invention, it is possible to correct blur and defocus of the image. In particular, according to one embodiment of the present invention, it is possible to more rapidly correct blur and defocus of an image while suppressing image quality deterioration.

### BRIEF DESCRIPTION OF THE DRAWINGS

FIG. 1 is a block diagram showing a first configuration example of an information processing device according to an embodiment of the present invention;

FIG. 2 is a diagram illustrating the summary of a method of estimating an initial estimated PSF;

FIG. 3 is a diagram illustrating a generation method of generating a cepstrum with respect to a blurred image;

FIGS. 4A, 4B and 4C are diagrams illustrating a calculation method of calculating a maximum value of a bright point with respect to a cepstrum;

FIG. 5 is a diagram illustrating a determination method of determining whether or not estimation of an initial estimated PSF is successful;

FIG. 6 is a diagram illustrating a generation method of generating an initial estimated PSF;

FIG. 7 is a diagram illustrating a method of generating an initial value U_init of a structure U;

FIG. 8 is a diagram illustrating an interpolation method using bilinear interpolation;

FIGS. 9A and 9B are diagrams illustrating a support restriction process performed by a support restriction unit;

FIG. 10 is a flowchart illustrating a repeated update process;

FIG. 11 is a block diagram showing a second configuration example of an information processing device according to an embodiment of the present invention;

FIG. 12 is a diagram illustrating a repeated update process performed with respect to a YUV space;

FIG. 13 is a block diagram showing a third configuration example of an information processing device according to an embodiment of the present invention;

FIG. 14 is a first diagram illustrating a paste margin process;

FIG. 15 is a second diagram illustrating a paste margin process;

FIG. 16 is a block diagram showing a configuration example of an image processing device according to an embodiment of the present invention;

FIG. 17 is a block diagram showing a detailed configuration example of a mask generation unit;

FIG. 18 is a flowchart illustrating an image correction process;

FIG. 19 is a flowchart illustrating a mask generation process;

FIG. 20 is a diagram illustrating an example of a pseudo-color generated when the image correction process of FIG. 18 is performed without using a mask image;

FIG. 21 is a diagram illustrating an example of a pseudo-color generated when the image correction process of FIG. 18 is performed without using a mask image; and

FIG. 22 is a block diagram showing a configuration example of a computer.

### DESCRIPTION OF THE PREFERRED EMBODIMENTS

Hereinafter, modes (hereinafter, referred to as embodiments) carrying out the present invention will be described. In addition, the description will be given in the following order.

1. First Embodiment

2. Modified Example 1

3. Second Embodiment

4. Modified Example 2

### 1. First Embodiment

### Configuration of Information Processing Device

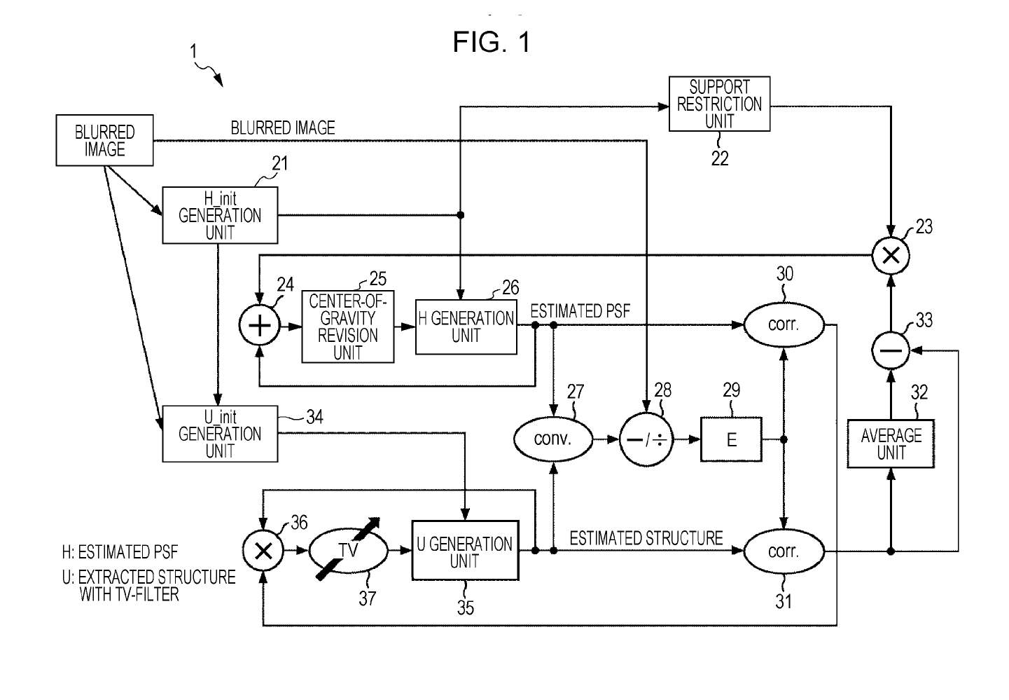

FIG. 1 is a block diagram showing a first configuration example of an information processing device 1 according to a first embodiment of the present invention.

An image compressed by Joint Photographic Experts Group (JPEG) compression, in which blur occurs by hand shaking at the time of photographing, is input blur image to this information processing device 1.

The information processing device 1 separates the input blurred image into a plurality of blocks g, and initially estimates a point spread function h indicating blur which occurs in the block g and a structure f indicating the component having a large amplitude, a flat portion and an edge of the block g in each block.

The information processing device 1 repeatedly updates the point spread function h and the structure f, both of which are initially estimated in each block, so as to be close to a true point spread function and a true structure.

In addition, in the following description, the point spread function h when update is performed only k times is referred to as a point spread function h^{k} and the structure f when update is performed only k times is referred to as a structure f^{k}.

In addition, if it is not necessary to distinguish between the point spread functions h^{k} of the blocks, the point spread function is simply referred to as a point spread function H^{k}. In addition, if it is not necessary to distinguish between the structures f^{k} of the blocks, the structure is simply referred to as a structure U^{k}. In addition, if it is not necessary to distinguish between the blocks g, the block is simply referred to as a blurred image G.

The information processing device 1 includes an H_init generation unit 21, a support restriction unit 22, a multiplying unit 23, an adding unit 24, a center-of-gravity revision unit 25, an H generation unit 26, a convolution unit 27, a processing unit 28, a residual error generation unit 29, a correlation unit 30, a correlation unit 31, an average unit 32, a subtraction unit 33, a U_init generation unit 34, a U generation unit 35, multiplying unit 36 and a total variation filter 37.

The blurred image G is input to the H_init generation unit 21. The H_init generation unit 21 detects a feature point on a cepstrum from a luminance value (Y component) of a pixel configuring the input blurred image G, performs straight line estimation of PSF, and supplies an initial estimated PSF obtained by linear estimation to the support restriction unit 22 and the H generation unit 26 as an initial value H_init (=H⁰) of the point spread function H.

The H_init generation unit 21 may detect the feature point on a cepstrum from an R component, a G component, a B component, and a R+G+B component obtained by adding the R component, the G component and the B component in addition to the Y component of the pixel configuring the input blurred image G and perform straight line estimation of the PSF.

The support restriction unit 22 generates support restriction information for updating only the vicinity of the initial value H_init (=initial estimated PSF) from the H_init generation unit 21 as an update target region and supplies the support restriction information to the multiplying unit 23.

Here, the support restriction information indicates mask information in which only the vicinity of the initial estimated PSF is the update target region and a region other than the update target region is fixed to zero.

The multiplying unit 23 extracts only that corresponding to a subtracted result present in the periphery of the initial estimated PSF from a subtracted result U^{k}o(G−H^{k}OU^{k})−mean(H^{k}) from the subtraction unit 33 based on the support restriction information from the support restriction unit 22 and supplies the extracted result to the adding unit 24.

That is, for example, the multiplying unit 23 multiplies the support restriction information from the support restriction unit 22 and the subtracted result U^{k}o(G−H^{k}OU^{k})−mean(H^{k}) from the subtraction unit 33 corresponding thereto together, extracts only that corresponding to the subtracted result present in the periphery of the PSF, and supplies the extracted result to the adding unit 24.

In addition, o denotes a correlation operation and O denotes a convolution operation. In addition, mean (H^{k}) denotes the mean value of the point spread function H^{k}.

The adding unit 24 multiplies a value U^{k}o(G−H^{k}OU^{k}) of the value U^{k}o(G−H^{k}OU^{k})−mean(H^{k}) from the multiplying unit 23 by an undefined multiplier λ. Then, the adding unit 24 adds the point spread function H^{k} from the H generation unit 26 to a value λU^{k}o(G−H^{k}OU^{k})−mean(H^{k}) obtained by the result, and applies an undefined multiplying method of Lagrange to a value H^{k}+λU^{k}o(G−H^{k}OU^{k})−mean(H^{k}) obtained by the result, thereby calculating a value a as a solution of the undefined multiplier λ.

The adding unit 24 substitutes the value a calculated by the undefined multiplying method of Lagrange to the value H^{k}+λU^{k}o(G−H^{k}OU^{k})−mean(H^{k}) and supplies a value H^{k}+aU^{k}o(G−H^{k}OU^{k})−mean(H^{k}) obtained as the result to the center-of-gravity revision unit 25.

In this way, H^{k}+aU^{k}o(G−H^{k}OU^{k})−mean(H^{k})=H^{k}+ΔH^{k} obtained with respect to each of the plurality of blocks configuring the blurred image is supplied to the center-of-gravity revision unit 25.

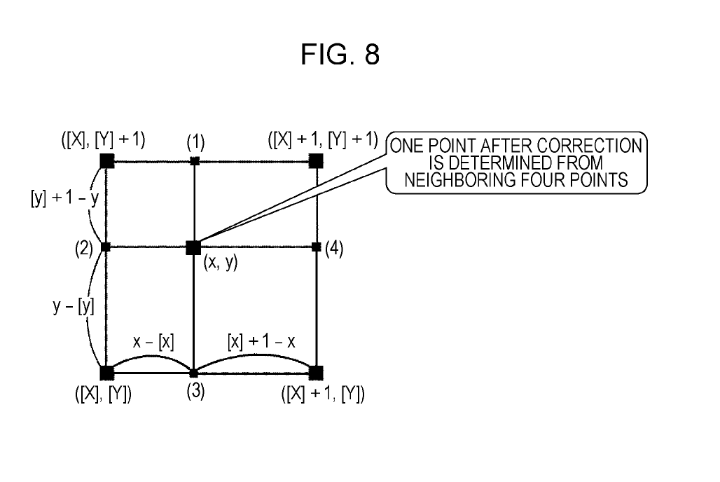

The center-of-gravity revision unit 25 moves the center of the point spread function H^{k}+ΔH^{k} (ΔH^{k} denotes a updated part) to the center (the center of the initial value H_init of the point spread function) of the screen by bilinear interpolation, and supplies the point spread function H^{k}+ΔH^{k}, the center of which is moved, to the H generation unit 26. The details thereof will be described later with reference to FIG. 8.

The H generation unit 26 supplies the initial value H_init from the H_init generation unit 21 to the adding unit 24, the convolution unit 27 and the correlation unit 30 as a point spread function H⁰.

The H generation unit 26 supplies the point spread function H^{k}+ΔH^{k} from the center-of-gravity revision unit 25 to the adding unit 24, the convolution unit 27 and the correlation unit 30 as a point spread function H^{k+1} after update.

In addition, when a point spread function H^{k-1}+ΔH^{k-1} obtained by updating a point spread function H^{k-1} is supplied from the center-of-gravity revision unit 25, the H generation unit 26 similarly supplies the point spread function H^{k-1}+ΔH^{k-1} from the center-of-gravity revision unit 25 to the adding unit 24, the convolution unit 27 and the correlation unit 30 as a point spread function H^{k} after update.

The convolution unit 27 performs the convolution operation of the point spread function H^{k} from the H generation unit 26 and the structure U^{k} from the U generation unit 35 and supplies the operation result H^{k}OU^{k} to the processing unit 28.

The processing unit 28 subtracts the operation result H^{k}OU^{k} from the convolution unit 27 from the input blurred image G and supplies the subtracted result G−H^{k}OU^{k} to the residual error generation unit 29.

The residual error generation unit 29 supplies the subtracted result G−H^{k}OU^{k} from the processing unit 28 to the correlation unit 30 and the correlation unit 31 as a residual error E^{k}.

The correlation unit 30 performs correlation operation of the residual error E^{k} from the residual error generation unit 29 and the point spread function H^{k} from the H generation unit 26 and supplies the operation result H^{k}o(G−H^{k}OU^{k}) to the multiplying unit 36.

The correlation unit 31 performs correlation operation of the residual error E^{k} from the residual error generation unit 29 and the structure U^{k} from the U generation unit 35 and supplies the operation result U^{k}o(G−H^{k}OU^{k}) to the subtraction unit 33.

The point spread function H^{k} is supplied from the H generation unit 26 to the average unit 32 through the convolution unit 27, the processing unit 28, the residual error generation unit 29, and the correlation unit 31.

The average unit 32 calculates the mean value mean(H^{k}) of the point spread function H^{k} from the correlation unit 31 and supplies the mean value to the subtraction unit 33.

The subtraction unit 33 subtracts mean(H^{k}) from the average unit 32 from the operation result U^{k}o(G−H^{k}OU^{k}) supplied from the correlation unit 31 and supplies the subtracted result U^{k}o(G−H^{k}OU^{k})−mean(H^{k}) obtained as the result to the multiplying unit 23.

The U_init generation unit 34 reduces the input blurred image G (block g) using the initial value H_init (=initial estimated PSF) generated by the H_init generation unit 21 to an initial estimated PSF size and returns the convoluted PSF to one point, thereby generating an image from which blur of the blurred image G is eliminated (reduced), that is, a reduced image.

In addition, the U_init generation unit 34 enlarges the reduced image to an initial estimated PSF size so as to generate an image defocused by enlargement, that is, an image from which blur is eliminated, sets the generated image to the initial value U_init of the structure U, and supplies the generated image to the U generation unit 35.

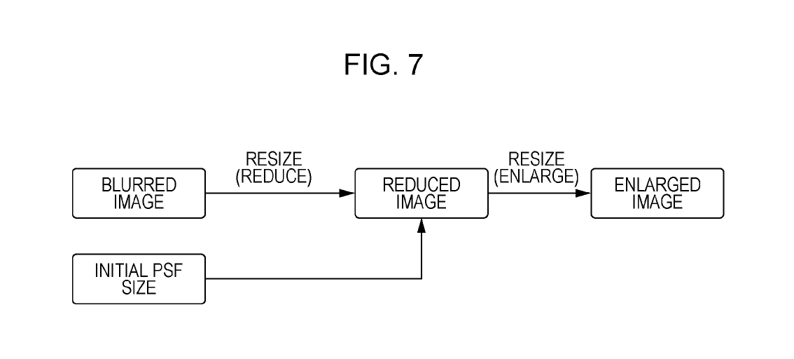

In addition, the details of the method of setting the initial value U_init by the U-init generation unit 34 will be described with reference to FIG. 7.

The U generation unit 35 supplies the structure U^{k+1} from the total variation filter 37 to the convolution unit 27, the correlation unit 31 and the multiplying unit 36.

In addition, the structure U^{k} is supplied from the total variation filter 37 to the U generation unit 35. The U generation unit 35 supplies the structure U^{k} from the total variation filter 37 to the convolution unit 27, the correlation unit 31 and the multiplying unit 36.

The multiplying unit 36 multiplies the operation result H^{k}O(G−H^{k}OU^{k}), from correlation unit 30 by the structure U^{k} from the U generation unit 35, and supplies the multiplied result U^{k}{H^{k}O(G−H^{k}OU^{k})} to the total variation filter 37 as the structure after update.

The total variation filter 37 separates the multiplied result U^{k}{H^{k}O(G−H^{k}OU^{k})} from the multiplying unit 36 into the structure component and the texture component and supplies the structure component obtained by separation to the U generation unit 35 as a next structure U^{k+1} to be updated.

As described above, the convolution unit 27 to the correlation unit 31, the U generation unit 35, the total variation filter 37 and the like perform the update of the structure U° by the Richardson-Lucy method using the initial value H_init (=H⁰) of the point spread function H generated by the H_init generation unit 21.

In addition, the convolution unit 27 to the correlation unit 31, the U generation unit 35, the total variation filter 37 and the like perform the update of the structure U^{k} by the Richardson-Lucy method using the newest point spread function H^{k} obtained by update, if the point spread function H^{k-1} is updated.

In the Richardson-Lucy method, with respect to the structure U^{k+1} obtained by the update of the structure U^{k}, since amplified noise or generated ringing is reduced by the separation of the structure component and the texture component by the total variation filter 37, it is possible to markedly suppress noise and ringing.

In addition, the total variation filter 37 is described in “Structure-Texture Image Decomposition Modeling, Algorithms, and Parameter Selection (Jean-Francois Aujol)” in detail.

In addition, in the total variation filter 37, a filter threshold indicating a boundary between the structure component and the texture component is set as one parameter and the parameter is adjusted such that more details are included in the output structure component.

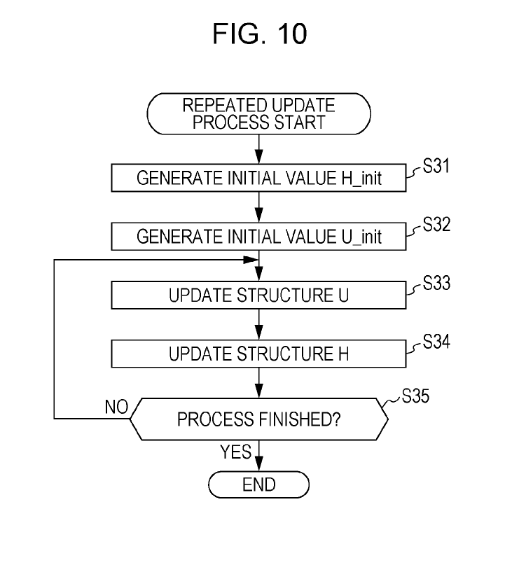

However, in an initial step of a repeated update process (which will be described later with reference to FIG. 10) of alternately and repeatedly updating the structure U^{k} and the point spread function H^{k}, since the point spread function H^{k} is not sufficiently updated, many errors may be included in the point spread function H^{k}.

Accordingly, if the update of the structure U^{k} is performed using the point spread function H^{k} including many errors, ringing corresponding to the errors included in the point spread function H^{k} is generated in the structure U^{k+1} obtained by the update.

Similarly, even with respect to the structure U^{k}, ringing or the like corresponding to the errors included in the point spread function H^{k-1} is generated.

In addition, similarly, the point spread function H^{k} updated using the structure U^{k}, in which ringing or the like is generated, is adversely affected.

To this end, while the point spread function H^{k} is not sufficiently updated, the filter threshold set by the total variation filter 37 may be set to be high so as to more markedly lower ringing and noise, such that the updated structure U does not deteriorate due to ringing generation or the like.

In addition, if the point spread function H^{k} is updated to some extent so as to be close to the true point spread function, the filter threshold set by the total variation filter 37 is set to be low such that the restoration of the details is performed using the true point spread function H^{k}.

That is, while the point spread function H^{k} is not sufficiently updated, the filter threshold is set to be high such that the total variation indicating a difference in absolute value sum between luminances of neighboring pixels among the pixels configuring the structure U^{k} output from the total variation filter 37 is decreased.

In addition, if the point spread function H^{k} is updated to some extent so as to be close to the true point spread function, the filter threshold is set to be low such that the total variation of the structure U^{k} output from the total variation filter 37 is no longer decreased.

In this way, in the total variation filter 37, the structure U^{k} is smoothened while leaving an edge included in the structure U^{k}, such that ringing and noise included in the structure U are lowered.

In addition, in the first embodiment, regardless of the update degree of the point spread function H^{k}, in a state in which the filter threshold is sufficiently low, the total variation filter 37 is configured such that amplified noise or generated ringing in the structure U^{k} are lowered by the separation of the structure component and the texture component by the total variation filter 37.

The H generation unit 26 to the residual error generation unit 29, the correlation unit 31, the U generation unit 35 and the like perform the update of the point spread function H^{k} by a steepest descent method (Landweber method) using the initial value U_init of the structure U^{k}.

The H generation unit 26 to the residual error generation unit 29, the correlation unit 31, the U generation unit 35 and the like perform the update of the point spread function H^{k} by a steepest descent method (Landweber method) using the new structure U^{k} obtained by update, when the structure U^{k-1} is updated.

Hereinafter, a process of updating the point spread function h^{k} of a predetermined block g will be described as update of the point spread function H^{k} by the steepest descent method, using the new structure f^{k} obtained by update of a predetermined block g among the plurality of blocks configuring the blurred image as the structure U^{k}.

Here, if the structure f^{k} of a current time is f and the point spread function h^{k} of the current time is h, a cost function is given by Equation 1.

Equation 1

e²=∥g−h*f∥²

In addition, in Equation 1, ∥•∥ denotes a norm and * denotes multiplication.

If the structure f of the current time is fixed, for the purpose of minimizing e² of Equation 1, as expressed by Equation 2, Equation 1 is partially differentiated by a variable h (point spread function h) so as to obtain a descent direction.

$$\begin{matrix}Equation 2 & \\ ∇ {e}^{2} = \frac{ {e}^{2}}{ h} ( - 2 ) fo ( g - h ⊗ f ) & 2\end{matrix}$$

If the point spread function h at the current time is searched for along the descent direction obtained by Equation 2, a minimum value of Equation 2 is present. If the current point spread function h proceeds by a step size λ in the descent direction obtained by Equation 2, as expressed by Equation 3, it is possible to obtain an updated point spread function h.

Equation 3

h^{k+1}=h^{k}+λf^{k}o(g−h^{k} [symbol] f^{k}) (3)

In Equations 2 and 3, a white circle (o) denotes a correlation operator and a symbol surrounding a cross mark (x) by a white circle (O) denotes a convolution operation.

In Equation 3, the point spread function h^{k+1} denotes the point spread function after update and the point spread function h^{k} denotes the point spread function h (the point spread function before update) of the current point. In addition, the structure f^{k} denotes the structure f of the current time.

However, since the point spread function h^{k+1} is forced to Σⁱᵢ₌₁h(i)=1 in the point spread function h^{k+1}(i) of each of the plurality of blocks configuring the blurred image, it is normalized by a loop formed by the H generation unit 26 to the residual error generation unit 29, the correlation unit 31, the U generation unit 35, and the like. Accordingly, when the updated part Δh^{k} of the point spread function h^{k} has the same sign as the point spread function h^{k}, the point spread function h^{k+1} is returned to the value h^{k} before update as the normalization result.

In Equation 3, if an undefined multiplying method of Lagrange is applied in addition to restraint of

$${\sum }_{i} h ( i ) = 1 , \qquad Equation 4$$

Equation 5 is derived.

Equation 5

h^{k+1}=h^{k}+λf^{k}o(g−h^{k} [symbol] f^{k})−mean(h) (4)

In addition, in Equation 5, mean(h) denotes the mean value of h^{k}. mean(h) is subtracted by the subtraction unit 33.

In addition, since the center may be deviated from the screen center while the point spread function h^{k} is updated by a rounding error, an inaccurate residual error e may be obtained and thus the update (restoration) of the structure f^{k} may be adversely affected. Accordingly, the center-of-gravity revision unit 25 performs parallel movement by bilinear interpolation of 1 pixel (pix) or less such that the center of the point spread function h^{k}+Δh^{k}(=h^{k}+1) after update is located on the screen center.

The information processing device 1 calculates the structures U^{k} after update by displaying blocks, from which blur is eliminated, from the blocks configuring the blurred image, as described above. In addition, the information processing device 1 configures the calculated structures U^{k} to one image so as to acquire an original image, from which blur is eliminated.

### Method of Estimating Initial Estimated PSF

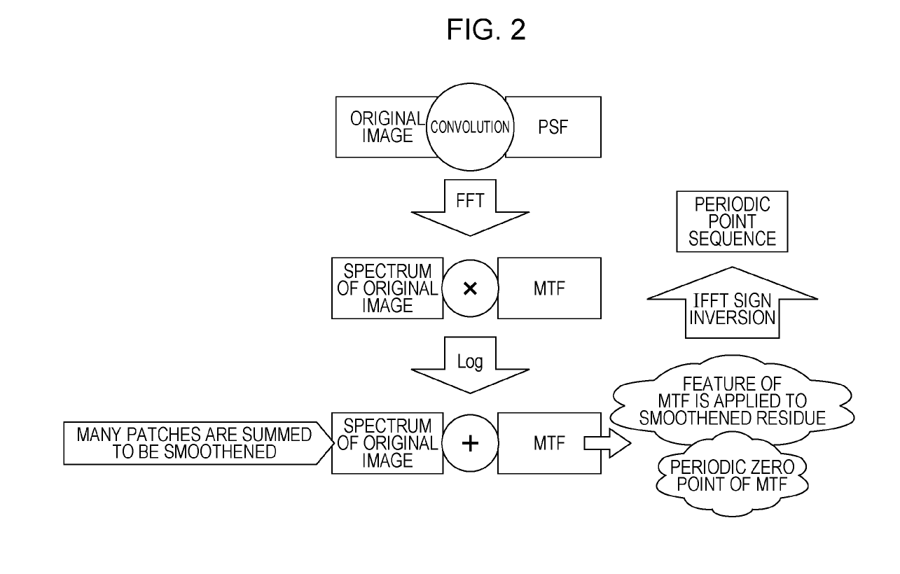

Next, a summary of the method of estimating the initial estimated PSF, which is performed by the H_init generation unit 21, will be described with reference to FIG. 2.

The blurred image may be modeled by convolution of the original image (original image corresponding to the blurred image), in which blur does not occur, and the PSF.

The spectrum of the straight-line PSF has a feature in which the length of the blur periodically falls to a zero point and, even in the spectrum of the blurred image, the length of the blur periodically falls to the zero point by convolution of the original image and the PSF.

By obtaining an interval and a direction of falling to the zero point, it is possible to approximate the length and the direction of the straight-line blur of the PSF. Thus, the blurred image is subjected to Fast Fourier Transform (FFT) so as to calculate the spectrum of the blurred image, and the Log (natural log) of the calculated spectrum is taken so as to be converted into a sum of the spectrum of the original image and the spectrum (MTF) of the PSF.

Since necessary information is only MTF, many patches are summed so as to be averaged with respect to the spectrum of the blurred image such that the feature of the spectrum of the original image is lost. Thus, it is possible to show only the feature of the MTF.

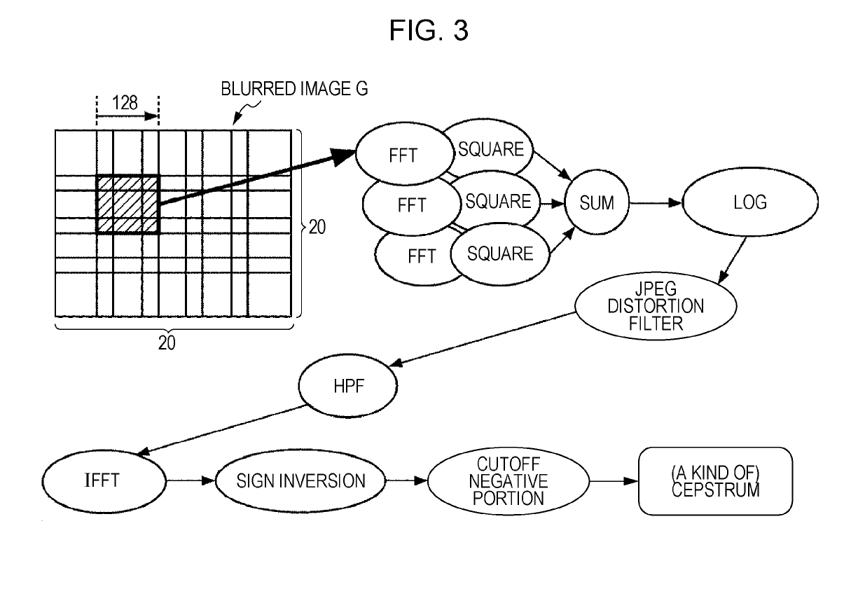

Next, the detailed method of estimating the initial estimated PSF will be described with reference to FIGS. 3 to 6.

FIG. 3 is a diagram illustrating a generation method of generating a cepstrum with respect to a blurred image.

The H_init generation unit 21 separates the input blurred image into the plurality of blocks, performs the Fast Flourier Transform (FFT) with respect to each of the separated blocks, and calculates the spectrum corresponding to each block.

That is, for example, the H_init generation unit 21 performs the FFT with respect to any one of the Y component, the R component, the G component, the B component and the R+G+B component of the pixel configuring the block obtained by separating the blurred image, and calculates the spectrum corresponding thereto.

In addition, the H_init generation unit 21 takes the natural log with respect to the sum of squares of the spectrum corresponding to each block and eliminates distortion by a JPEG elimination filter for eliminating distortion generated at the time of JPEG compression. To this end, it is possible to prevent spectrum precision from being influenced by the distortion generated at the time of JPEG compression.

In addition, the H_init generation unit 21 performs filtering processing by a High Pass Filter (HPF) in order to highlight periodic reduction due to blurring with respect to the natural log log Σ|gs|² of the sum of squares of the spectrum gs corresponding to each block g after eliminating the distortion by the JPEG elimination filter, and reduces a gradual change due to blurring.

The H_init generation unit 21 performs Inverse Fast Fourier Transform (IFFT) with respect to the residual error component deducted from a moving average, that is, the natural log log Σ|gs|² of the sum of squares of the spectrum after the filtering process by the HPF so as to generate a kind of cepstrum.

In detail, the H_init generation unit 21 inverts the positive/negative sign with respect to the natural log log Σ|gs|² of the sum of squares of the spectrum after the filtering process by the HPF. The H_init generation unit 21 discards a portion having a negative sign from the log Σ|gs|², of which the positive/negative sign is inverted, and generates a kind of cepstrum based on only a portion having a positive sign.

The H_init generation unit 21 calculates a maximum value of a bright point with respect to the generated cepstrums.

That is, the H_init generation unit 21 calculates a cepstrum having a maximum value in the generated cepstrums as the maximum value of the bright point.

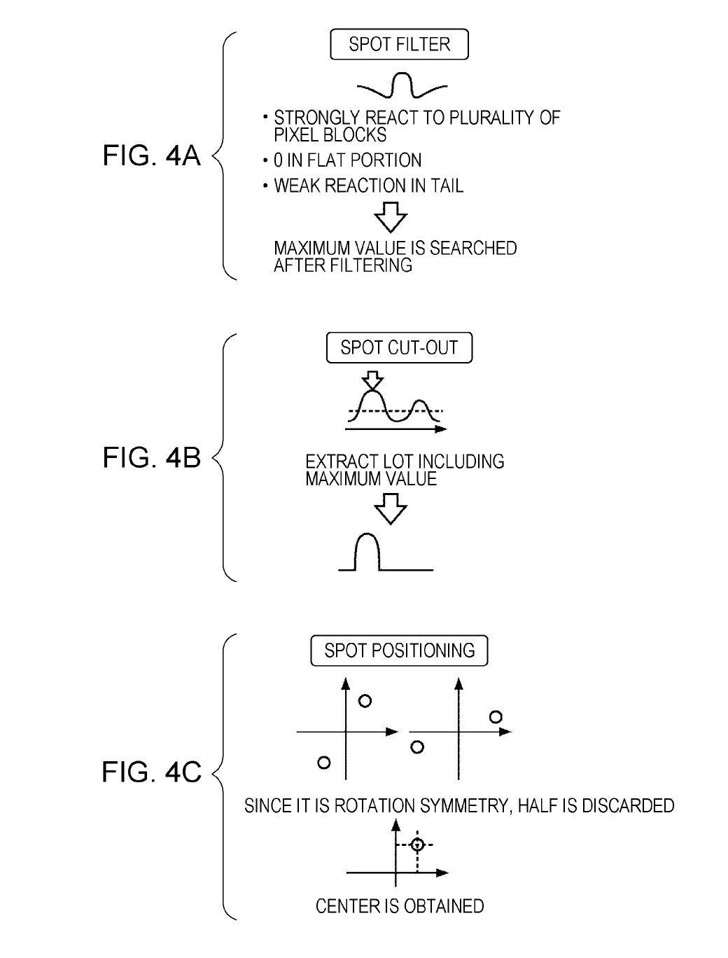

Next, FIG. 4 is a diagram illustrating a calculation method of calculating the maximum value of the bright point with respect to the generated cepstrums.

The H_init generation unit 21 performs a filtering process by a spot filter strongly reacting to a plurality of pixel blocks with high luminance as compared with peripheral pixels, with respect to the generated cepstrums, as shown in FIG. 4A.

In addition, the H_init generation unit 21 extracts a lot including a maximum value from the cepstrums after the filtering process by the spot filter shown in FIG. 4A as a spot, as shown in FIG. 4B.

In addition, the H_init generation unit 21 decides a spot position as shown in FIG. 4C. In addition, the spot position indicates the center position of the spot from a plurality of cepstrums configuring a lot including a maximum value.

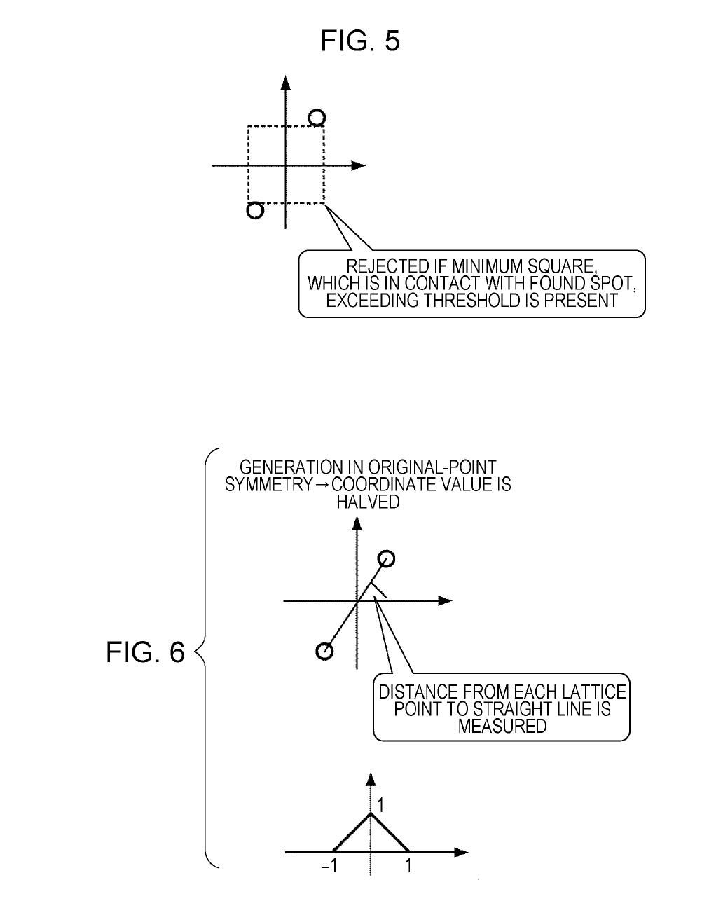

Next, FIG. 5 is a diagram illustrating a determination method of determining whether or not estimation of an initial estimated PSF is successful. In addition, a method of estimating the initial estimated PSF will be described later with reference to FIG. 6.

Since bright points are symmetrical with respect to an original point, another feature point is present at an origin symmetry position. That is, two spots which are symmetrical with the original point are present as feature points.

If a value exceeding a threshold within a minimum square range which is in contact with these two spots is present, that is, if a cepstrum having a value exceeding the threshold within the minimum square range is present, the H_init generation unit 21 determines that the initial estimation of the initial estimated PSF fails.

In this case, the H_init generation unit 21 approximates the initial estimated PSF which is initially estimated to the PSF in which a blur distribution follows a Gauss distribution (regular distribution) and sets a PSF capable of obtaining that result as the initial value H_init.

If a value exceeding the threshold within the minimum square range which is in contact with these two spots is not present, that is, if a cepstrum having the value exceeding the threshold within the minimum square range is not present, the H_init generation unit 21 determines that the initial estimation of the initial estimated PSF succeeds and sets the initial estimated PSF as the initial value H_init.

Next, FIG. 6 shows a generation method of estimating (generating) an initial estimated PSF based on two spots.

If that exceeding the threshold within the minimum square range which is in contact with these two spots is not present, the H_init generation unit 21 generates a straight line connecting the spot positions symmetrically with respect to the original point as the initial estimated PSF and sets the initial estimated PSF as the initial value H_init, as shown in FIG. 6.

### Method of Generating Initial Value U_init of Structure U^{k}

Next, a method of generating an initial value U_init of a structure U^{k}, which is performed by the U_init generation unit 34, will be described with reference to FIG. 7.

The U_init generation unit 34 reduces the input blurred image to the size of the initial estimated PSF so as to generate a reduced image and enlarges the generated reduced image to the size of the initial estimated PSF so as to generate an enlarged image. Then, the generated enlarged image is separated into the structure component and the texture component and supplies the structure component obtained by separation to the U generation unit 35 as the initial value U_init of the structure U.

That is, for example, the U_init generation unit 34 reduces the block configuring the input blurred image to the same reduction size as a reduction size for reducing the initial estimated PSF of the block supplied from the H_init generation unit 21 to one point so as to generate the reduced block, from which blur generated in the block is eliminated (reduced).

Then, the U_init generation unit 34 enlarges the generated reduced block to the same enlargement size as an enlargement size for enlarging the initial estimated PSF reduced to one point to the original initial estimated PSF so as to generate an enlarged image in which defocus is generated but blur is not generated.

The U_init generation unit 34 supplies the generated enlarged block to the U generation unit 35 as the initial value U_init (structure U⁰).

### Method of Revising Center of Point Spread Function

Next, the method of revising the center, which is performed by the center-of-gravity revision unit 25, will be described with reference to FIG. 8.

FIG. 8 is a diagram illustrating an interpolation method using bilinear interpolation.

As described above, while the H generation unit 26 to the residual error generation unit 29, the correlation unit 31, the U generation unit 35 and the like update the point spread function H^{k}, since the center may be deviated from the screen center by the rounding error, the center-of-gravity revision unit 25 performs parallel movement by bilinear interpolation such that the center of the point spread function H^{k}+ΔH^{k} is located on the screen center, as shown in FIG. 8.

### Support Restriction Process

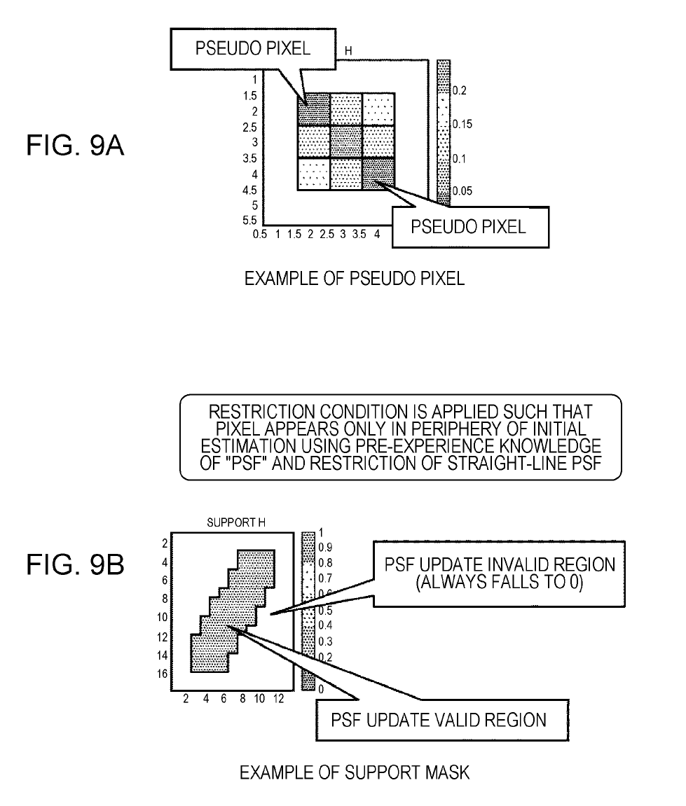

Next, the support restriction process performed by the support restriction unit 22 will be described with reference to FIGS. 9A and 9B.

If the H generation unit 26 to the residual error generation unit 29, the correlation unit 31, the U generation unit 35 and the like update the point spread function H^{k}, the degree of freedom of the updated part ΔH^{k} is high and, as shown in FIG. 9A, a pseudo-pixel to which blur indicated by the point spread function H^{k}+ΔH^{k} after update is not accurately applied at a place separated from the true PSF (point spread function). Therefore, the support restriction unit 22 permits the update of only the vicinity of the initial estimated PSF, as shown in FIG. 9B, and the region other than the vicinity of the initial estimated PSF is masked even when the pixel is present in the updated part ΔH^{k}, such that support restriction is applied so as to update only the vicinity of the initial estimated PSF.

In the update loop of the point spread function H^{k}, if the updated portion ΔU^{k} of the structure U^{k} is gradually reduced to some degree, the residual error E^{k}=G−H^{k}*(Uₖ+ΔU^{k}) is saturated (the residual error E almost does not vary) and the update of the point spread function H^{k} is stopped. Accordingly, by adjusting the filter threshold set by the total variation filter 37, the residual error E^{k} is intentionally lowered (reduced) and is triggered so as to resume the update of the point spread function H^{k}.

In addition, in the total variation filter 37, upon a final output, it is possible to overcome a lack of detail due to the structure output by lowering (decreasing) the filter threshold.

The information of the structure U^{k} used at the time of the update of the point spread function H^{k} may use the sum of the R/G/B3 channel (the total sum of the R component, the G component and the B component) in addition to the luminance Y (the Y component indicating the total sum of the multiplied results obtained by multiplication by respective weights of the R component, the G component and the B component). This is different from the case where the update is performed using only the luminance Y in that a large feedback may be obtained similarly to the G channel with respect to even the blurred image in which an edge, in which blur is applied to only the R/B channel, is present.

The information of the structure U^{k} used at the time of the update of the point spread function H^{k} may use the R component, the G component and the B component.

### Repeated Update Process

Next, a repeated update process performed by the information processing device 1 will be described with reference to the flowchart of FIG. 10.

In addition, in the repeated update process, an algorithm which does not separately update the point spread function H^{k} and the structure U^{k}, but alternately updates the point spread function H^{k} and the structure U^{k} based on the mutual initial values is used.

In steps S31 and S32, the initial estimation of the initial value H_init and the initial value U_init and the initialization of parameters, global variables and the like are performed.

That is, for example, in step S31, the H_init generation unit 21 detects the feature point on the cepstrum from the input blurred image G, performs the straight-line estimation of the PSF, sets the initial estimated PSF obtained by the straight-line estimation as the initial value H_init of the point spread function H, and supplies the initial value to the support restriction unit 22 and the H generation unit 26.

In step S32, the U_init generation unit 34 reduces the input blurred image to the initial estimated PSF size using the initial value H_init (=initial estimated PSF) set by the H_init generation unit 21 and returns the convoluted PSF to one point so as to generate the reduced image, from which blur of the blurred image is eliminated.

In addition, the U_init generation unit 34 enlarges the reduced image to the initial estimated PSF size so as to generate an image defocused by interpolation, from which blur is eliminated, and sets and supplies the initial value U_init of the structure U^{k} to the U generation unit 35.

That is, for example, the U_init generation unit 34 reduces the block configuring the input blurred image to the same reduction size as a reduction size for reducing the initial estimated PSF of the block supplied from the H_init generation unit 21 to one point so as to generate the reduced block, from which blur generated in the block is eliminated (reduced).

Then, the U_init generation unit 34 enlarges the generated reduced block to the same enlargement size as an enlargement size for enlarging the initial estimated PSF reduced to one point to the original initial estimated PSF so as to generate an enlarged block in which defocus is generated but blur is not generated.

The U_init generation unit 34 supplies the generated enlarged block to the U generation unit 35 as the initial value U_init (structure U⁰).

In a state in which both the structure U^{k} and the point spread function H^{k} are not accurately known, the structure U^{k} is updated using the newest function of the point spread function H^{k} in step S33, and the point spread function H^{k} is updated using the newest information of the structure U^{k} in step S34.

If the structure U^{k} and the point spread function H^{k} are alternately updated by this repetition, the structure U^{k} converges to a true structure U and the point spread function H^{k} converges to a true point spread function H.

That is, in step S33, the convolution unit 27 to the correlation unit 31, the U generation unit 35, the total variation filter 37 and the like perform the update of the structure U⁰ according to the Richardson-Lucy method of the related art using the initial value H_init (=initial estimated PSF) of the point spread function H^{k}.

In step S33, the convolution unit 27 convolutes the point spread function H⁰ which is the initial value H_init of the point spread function H^{k} from the H generation unit 26 and the structure U⁰ from the U generation unit 35 and supplies the operation result H⁰OU⁰ to the processing unit 28.

The processing unit 28 subtracts the operation result H⁰OU⁰ from the convolution unit 27 from the input blurred image G and supplies the subtracted result G−H⁰OU⁰ to the residual error generation unit 29.

The residual error generation unit 29 supplies the subtracted result G−H⁰OU⁰ from the processing unit 28 to the correlation unit 30 and the correlation unit 31.

The correlation unit 30 performs a correlation operation of the subtracted result G−H⁰OU⁰ from the residual error generation unit 29 and the point spread function H° from the H generation unit 26 and supplies the operation result H⁰o(G−H⁰OU⁰) to the multiplying unit 36.

The multiplying unit 36 multiplies the operation result H⁰o(G−H⁰OU⁰) from the correlation unit 30 by the structure U⁰ from the U generation unit 35, and supplies the multiplied result U⁰{H⁰o(G−H⁰OU⁰)} to the total variation filter 37 as the structure after update.

The total variation filter 37 performs a process of suppressing amplified noise or generated ringing with respect to the multiplied result U⁰{H⁰o(G−H⁰OU⁰)} from the multiplying unit 36.

The total variation filter 37 supplies the structure component between the structure component and the texture component of the multiplied result U⁰{H⁰o(G−H⁰OU⁰)} obtained by the process to the U generation unit 35.

The U generation unit 35 acquires the structure component supplied from the total variation filter 37 as a structure U¹ which is the update target of a next structure.

In addition, the U generation unit 35 supplies the structure U¹ to the convolution unit 27, the correlation unit 31 and the multiplying unit 36, in order to further update the acquired structure U¹.

In step S34, the H generation unit 26 to the residual error generation unit 29, the correlation unit 31, the U generation unit 35 and the like perform the update of the point spread function H⁰ using the initial value U_init of the structure U^{k} by the steepest descent method.

In addition, as described above in step S33, the residual error generation unit 29 supplies the subtracted result G−H⁰OU⁰ from the processing unit 28 to the correlation unit 31 in addition to the correlation unit 30.

In step S34, the correlation unit 31 performs a correlation operation of the subtracted result G−H⁰OU⁰ from the residual error generation unit 29 and the structure U⁰ from the U generation unit 35 and supplies the operation result U⁰o(G−H⁰OU⁰) to the subtraction unit 33.

The correlation unit 31 supplies the point spread function H⁰ supplied from the H generation unit 26 through the convolution unit 27, the processing unit 28 and the residual error generation unit 29 to the average unit 32.

The average unit 32 calculates the mean value mean(H⁰) of the point spread function H⁰ from the correlation unit 31 and supplies the mean value to the subtraction unit 33.

The subtraction unit 33 subtracts mean(H⁰) from the average unit 32 from the operation result U⁰o(G−H⁰OU⁰) supplied from the correlation unit 31 and supplies the subtracted result U⁰o(G−H⁰OU⁰)−mean(H⁰) obtained as the result to the multiplying unit 23.

The multiplying unit 23 extracts only a value corresponding to a subtracted result present in the periphery of the initial estimated PSF from a subtracted result U⁰o(G−H⁰OU⁰)−mean(H⁰) from the subtraction unit 33 based on the support restriction information from the support restriction unit 22 and supplies the extracted result to the adding unit 24.

The adding unit 24 multiplies a value U^{k}o(G−H^{k}OU^{k}) of the value U^{k}o(G−H^{k}OU^{k})−mean(H^{k}) from the multiplying unit 23 by an undefined multiplier λ. Then, the adding unit 24 adds the point spread function H^{k} from the H generation unit 26 to a value λU^{k}o(G−H^{k}OU^{k})−mean(H^{k}) obtained by the result, and applies an undefined multiplying method of Lagrange to a value H^{k}+λU^{k}o(G−H^{k}OU^{k})−mean(H^{k}) obtained by the result, thereby calculating a value a as a solution of the undefined multiplier λ.

The adding unit 24 substitutes the value a calculated by the undefined multiplying method of Lagrange to the value H^{k}+λU^{k}o(G−H^{k}OU^{k})−mean(H^{k}) and supplies a value H^{k}+aU^{k}o(G−H^{k}OU^{k})−mean(H^{k}) obtained as the result to the center-of-gravity revision unit 25.

In this way, H⁰+aU⁰o(G−H⁰OU⁰)−mean(H⁰)=H⁰+ΔH⁰ obtained with respect to each of the plurality of blocks configuring the blurred image is supplied to the center-of-gravity revision unit 25.

The center-of-gravity revision unit 25 moves the center of the point spread function H⁰+ΔH⁰ to the center (the center of the initial value H_init of the point spread function) of the screen by bilinear interpolation, and supplies the point spread function H⁰+ΔH⁰, the center of which is moved, to the H generation unit 26.

The H generation unit 26 obtains the point spread function H⁰+ΔH⁰ from the center-of-gravity revision unit 25 as a point spread function H¹ after update.

The H generation unit 26 supplies point spread function H¹ to the adding unit 24, the convolution unit 27 and the correlation unit 30 in order to further update the acquired point spread function H¹.

In step S35, it is determined whether or not the repeated update process is finished. That is, for example, it is determined whether or not the structure U^{k} after update (or at least one of the point spread function H^{k}) is converged. If it is determined that the structure U^{k} after update is not converged, the process returns to step S33.

The determination as to whether or not the structure U^{k} after update is converged is made depending on whether or not Σ|E^{k}|², sum of square of a value G−H^{k}OU^{k}(=E^{k}) corresponding to each of the plurality of blocks configuring the blurred image is less than a predetermined value, for example, by the residual error generation unit 29.

In addition, the total variation filter 37 may perform the determination depending on whether the total variation indicated by a sum of absolute differences between the luminances of neighboring pixels among the pixels configuring the structure U^{k} from the multiplying unit 36 varies from an increase to a decrease.

In step S33, the update of the structure U^{k} (for example, U¹) after update by the process of the preceding step S33 is performed by the Richardson-Lucy method using the point spread function H^{k} (for example, H¹) after update by the process of the preceding step S34.

That is, in step S33, the convolution unit 27 to the correlation unit 31, the U generation unit 35, the total variation filter 37 and the like perform the update of the structure U^{k} (for example, U¹) by the Richardson-Lucy method of the related art of the related art using the point spread function H^{k} (for example, H¹) after update by the process of the preceding step S34.

After the process of step S33 is finished, in step S34, the update of the point spread function H^{k} (for example, H¹) after update by the process of the preceding step S34 is performed by the steepest descent method using the structure U^{k} (for example, U¹) after update by the preceding step S33.

That is, in step S34, the H generation unit 26 to the residual error generation unit 29, the correlation unit 31, the U generation unit 35 and the like perform the update of the point spread function H^{k} (for example, H¹) by the steepest descent method using the structure U^{k} (for example, U¹) after update by the preceding step S33.

The process progresses from step S34 to step S35 and, hereinafter, the same process is repeated.

In addition, in step S35, if it is determined that the updated structure U^{k} is converged, the repeated update process is finished.

As described above, in the repeated update process, since the update of the structure U^{k} and the point spread function H^{k} is repeatedly performed such that the structure U^{k} is converged to the true structure U (and the point spread function H^{k} is converged to the true point spread function H), it is possible to suppress ringing or noise generated in the finally obtained structure U^{k}.

In addition, even in the state in which the PSF (=the point spread function H⁰) obtained as the initial value H_init is inaccurate, it is possible to obtain an accurate PSF, that is, a true PSF, or a PSF close to the true PSF.

In addition, by the support restriction of the PSF, since the initial value H_init (=initial estimated PSF) is updated along an initial estimated direction, it is possible to obtain the true PSF or the PSF close to the true PSF, without divergence.

### 2. Modified Example 1

### Modified Example of Repeated Update Process

In addition, in the repeated update process, for example, if the estimation (generation) of the initial value H_init (=the point spread function H⁰) succeeds in step S31, the update of the structure U⁰ is performed in initial value H_init in step S33, and, if the estimation (generation) of the initial value H_init fails in step S31, the PSF is approximated by the Gaussian (Gauss distribution) in step S33, such that the update of the structure U⁰ is performed using the approximated PSF as the initial value H_init. In this case, it is possible to prevent deterioration of the structure U⁰ by the deviation of the initial value H_init (=the initial estimated PSF).

In addition, although, in step S33, the convolution unit 27 to the correlation unit 31, the U generation unit 35, the total variation filter 37 and the like perform the update of the structure U^{k} by the Richardson-Lucy method of the related art, it is possible to more rapidly update the structure U^{k} to the true structure if the R-L high-speed algorithm of the related art obtained by increasing the speed of the process by the Richardson-Lucy method is used.

In addition, in the repeated update process of FIG. 10, although, in step S35, it is determined whether or not the repeated update process is finished depending on whether or not the structure U^{k} after update is converged, the present invention is not limited thereto.

That is, for example, in step S35, it may be determined whether or not a predetermined number of times of the update of the structure U^{k} and the point spread function H^{k} is performed and the repeated update process may be finished if it is determined that the predetermined number of times of update is performed. In addition, as the predetermined number of times, for example, a number of times without generating ringing even in a PSF with low precision or a number of times sufficient to cancel ringing slightly generated by the total variation filter 37 is preferable.

### Method of Applying Residual Deconvolution

Although, in the first embodiment of the present invention, the structure U^{k} obtained in a state in which the filter threshold of the total variation filter 37 is sufficiently low is a final output, a method by residual deconvolution of the related art using a blurred image and an updated structure U^{k} may be performed.

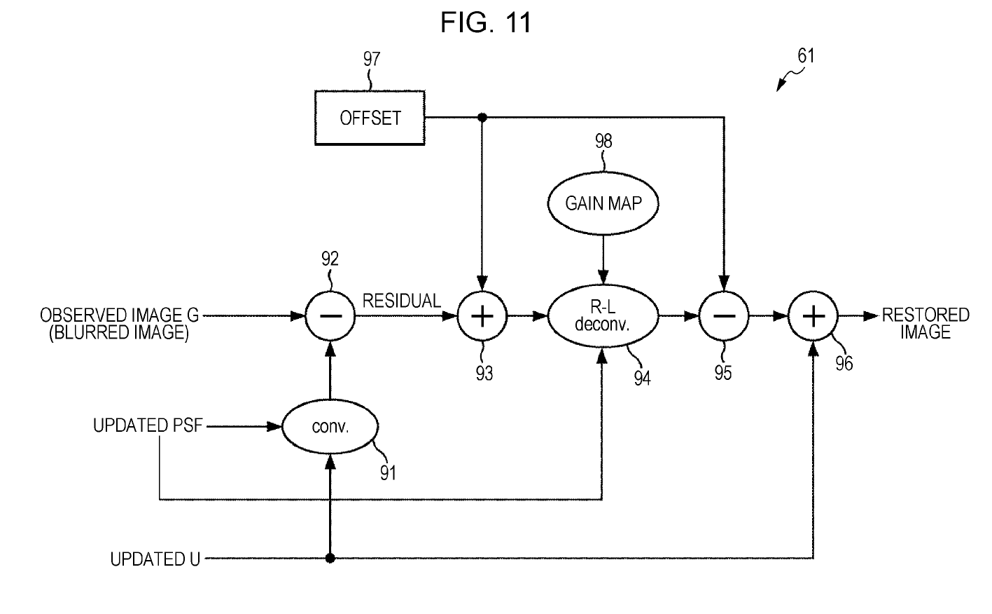

FIG. 11 shows a configuration example of an information processing device 61 which performs the method by the residual deconvolution of the related art using the blurred image and the updated structure U^{k}.

The information processing device 61 includes a convolution unit 91, a subtraction unit 92, an adding unit 93, an R-Ldeconv unit 94, a subtraction unit 95, an adding unit 96, an offset unit 97, and a gain map unit 98.

An updated H^{k} and an updated U^{k} are supplied to the convolution unit 91. The convolution unit 91 performs a convolution operation of the updated H^{k} and the updated U^{k} and supplies a value H^{k}OU^{k} obtained as the result to the subtraction unit 92.

A blurred image G is supplied to the subtraction unit 92. The subtraction unit 92 subtracts the value H^{k}OU^{k} from the convolution unit 91 from the supplied blurred image G and supplies the subtracted result G−H^{k}OU^{k} to the adding unit 93 as a residual error component (residual).

The adding unit 93 adds an offset value from the offset unit 97 to the residual error component G−H^{k}OU^{k} and supplies the added result to the R-Ldeconv unit 94, in order to enable the residual error component G−H^{k}OU^{k} from the subtraction unit 92 to become a positive value. In addition, in the adding unit 93, the reason why the offset value is added to the residual error component G−H^{k}OU^{k} so as to become the positive value is because the process by the R-Ldeconv unit 94 aims at a positive value.

The R-Ldeconv unit 94 performs residual deconvolution described in Lu Yuan, Jian Sun, Long Quan, Heung-Yeung Shum, Image deblurring with blurred/noisy image pairs, ACM Transactions on Graphics (TOG), v. 26 n. 3, July 2007 with respect to the added result from the adding unit 93, based on a gain map held in the gain map unit 98 and the updated H^{k}. In this way, it is possible to suppress ringing of the residual error component to which the offset value is added.

The subtraction unit 95 subtracts the same offset value as that added by the adding unit 93 from the processed result from the R-Ldeconv unit 94 and acquires the residual error component with suppressed ringing, that is, a restoration result of restoring the texture of the blurred image. In addition, the subtraction unit 95 supplies the acquired restoration result of the texture to the adding unit 96.

The updated structure U^{k} is supplied to the adding unit 96. The adding unit 96 adds the restoration result of the texture from the subtraction unit 95 and the supplied updated structure U^{k} and outputs a restored image obtained by eliminating blur from the blurred image, which is obtained as the result.

That is, for example, the adding unit 96 adds the restoration result of the texture and the updated structure U^{k}, both of which correspond to each of the blocks configuring the blurred image, and acquires a restored block obtained by eliminating blur from each of the block configuring the blurred image as the added result. In addition, the adding unit 96 acquires the restored blocks corresponding to the blocks configuring the blurred image, connects the acquired restored blocks, and generates and outputs a restored image.

The offset unit 97 holds an offset value added in order to enable the residual error component G−H^{k}OU^{k} to the positive value in advance. The offset unit 97 supplies the offset value held in advance to the adding unit 93 and the subtraction unit 95.

The gain map unit 98 holds the gain map used to adjust the gain of the residual error component G−H^{k}OU^{k} in advance.

As shown in FIG. 11, blur is caused in the updated structure U^{k} by the updated point spread function PSF (point spread function H^{k}), deconvolution (process by the R-Ldeconv unit 94) is performed with respect to the residual error component (residual component) G−H^{k}OU^{k} with the blurred image G, and that obtained as the result (the restoration result of restoring the texture of the blurred image) is added to the updated structure U^{k}, such that the detail information of the residual error is restored and thus a detailed restoration result is obtained.

Method of Applying to Color Space Other than RGB Space

In addition, although, in the first embodiment of the present invention, the repeated update process is performed with respect to the RGB space (the blurred image including the pixels expressed by the R component, the G component and the B component), the same repeated update process may be performed with respect to the other color space such as a YUV space.

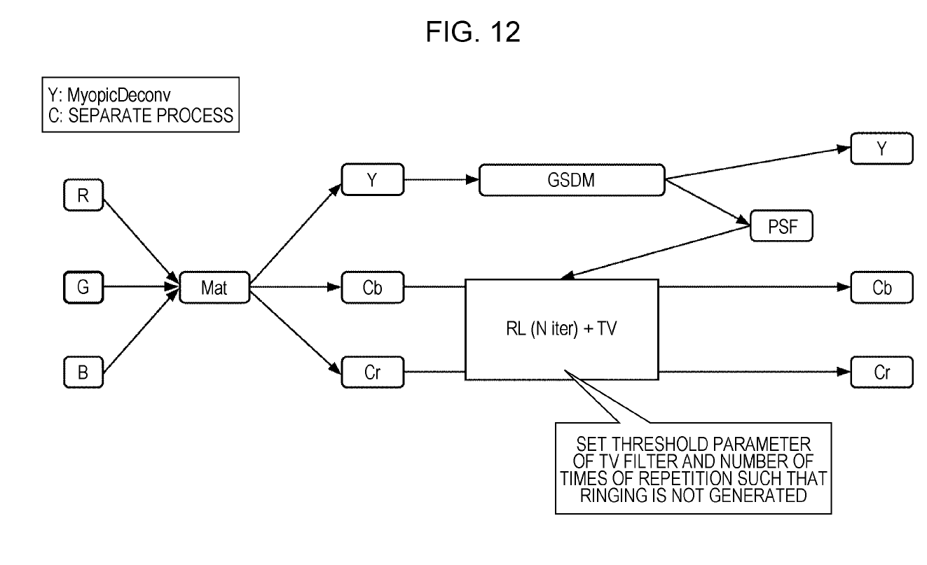

Next, FIG. 12 is a diagram illustrating a process of performing a repeated update process with respect to a YUV space.

As shown in FIG. 12, in the YUV space, after an accurate PSF is calculated by applying the repeated update process (GSDM, Gradual Structure Deconvolution Method) to only Y, that obtained by performing a process by the Richardson-Lucy method or the like using the calculated accurate PSF with respect to a U/V component so as not to generate ringing may be summed to Y.

In addition, although, in the above-described first embodiment, the point spread function H^{k} is updated using the steepest descent method and the structure U^{k} is updated using the Richardson-Lucy method, for example, the point spread function H^{k} may be updated using the Richardson-Lucy method and the structure U^{k} may be updated using the steepest descent method.

### 3. Second Embodiment

### Configuration of Information Processing Device

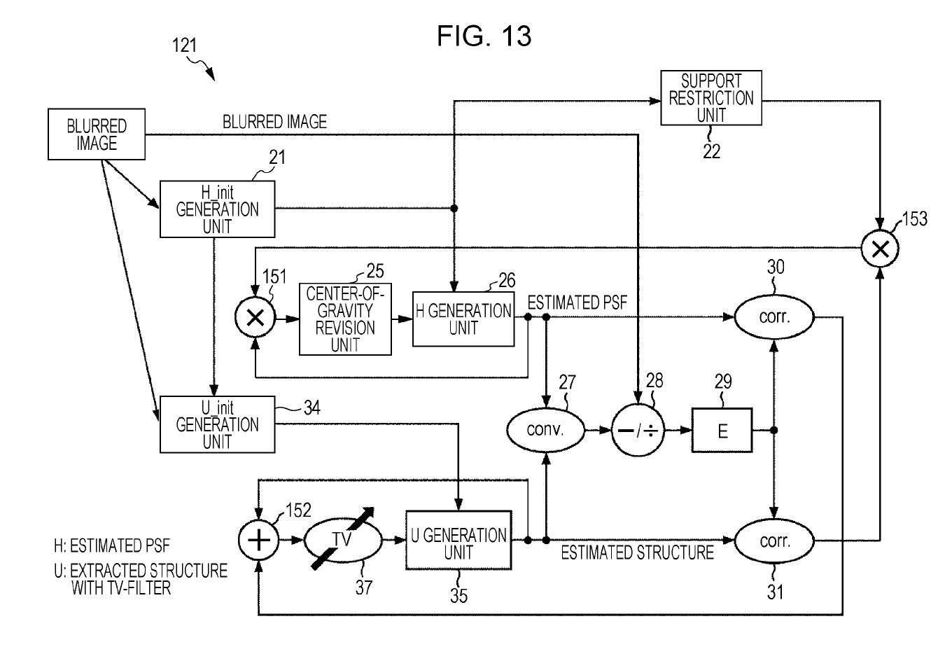

Next, the information processing device 121 for updating the point spread function H^{k} using the Richardson-Lucy method and updating the structure U^{k} using the steepest descent method will be described with reference to FIG. 13.

FIG. 13 shows the information processing device 121 according to a second embodiment of the present invention.

In addition, in the information processing device 121, since common components among the components of the information processing device 1 according to the first embodiment shown in FIG. 1 are denoted by the same reference numerals, the description thereof will be appropriately omitted.

That is, the information processing device 121 is equal to the information processing device 1 except that a multiplying unit 151 is provided instead of the adding unit 24, an adding unit 152 is provided instead of the multiplying unit 36, and a multiplying unit 153 is provided instead of the multiplying unit 23, the average unit 32 and the subtraction unit 33.

The operation result U^{k}o(G−H^{k}OU^{k}) corresponding to the peripheral region of the initial estimated PSF from the multiplying unit 153 and the point spread function H^{k} from the H generation unit 26 are supplied to the multiplying unit 151.

The multiplying unit 151 multiplies the operation result U^{k}o(G−H^{k}OU^{k}) from the multiplying unit 153 by the point spread function H^{k} from the H generation unit 26 and supplies the point spread function H^{k+1}=H^{k}U^{k}o(G−H^{k}OU^{k}) obtained as the result to the center-of-gravity revision unit 25.

The operation result H^{k}o(G−H^{k}OU^{k}) from the correlation unit 30 and the structure U^{k} from the U generation unit 35 are supplied to the adding unit 152.

The adding unit 152 multiplies the operation result H^{k}o(G−H^{k}OU^{k}) from the correlation unit 30 by an undefined multiplier λ and adds the structure U^{k} from the U generation unit 35 to a value λH^{k}o(G−H^{k}OU^{k}) obtained by the result. The adding unit 152 calculates the undefined multiplier λ by the undefined multiplying method of Lagrange with respect to the added result U^{k}+λH^{k}o(G−H^{k}OU^{k}) (=U^{k+1}) obtained by the result.

The adding unit 152 substitutes a constant a calculated as a solution of the undefined multiplier λ to the added result U^{k}+λH^{k}o(G−H^{k}OU^{k}) and supplies the structure U^{k+1}=U^{k}+aH^{k}o(G−H^{k}OU^{k}) obtained as the result to the total variation filter 37.

The operation result U^{k}o(G−H^{k}OU^{k}) from the correlation unit 31 and the support restriction information from the support restriction unit 22 are supplied to the multiplying unit 153.

The multiplying unit 153 extracts only the operation result corresponding to the peripheral region of the initial estimated PSF in the operation result U^{k}o(G−H^{k}OU^{k}) from the correlation unit 31 based on the support restriction information from the support restriction unit 22 and supplies the extracted operation result to the multiplying unit 151.

Even in this information processing unit 121, it is possible to obtain the same operation effect as the information processing device 1 according to the first embodiment.

### 4. Modified Example 2

Although, in the second embodiment, the point spread function H^{k} is updated using the Richardson-Lucy method and the structure U^{k} is updated using the steepest descent method, for example, the point spread function H^{k} and the structure U^{k} may be updated using the Richardson-Lucy method or the point spread function H^{k} and the structure U^{k} may be updated using the steepest descent method.

In addition, although, in the first and second embodiments, the repeated update process is performed with respect to the plurality of blocks configuring the blurred image, the blurred image itself may be subjected to the repeated update process as one block.

### Paste Margin Process

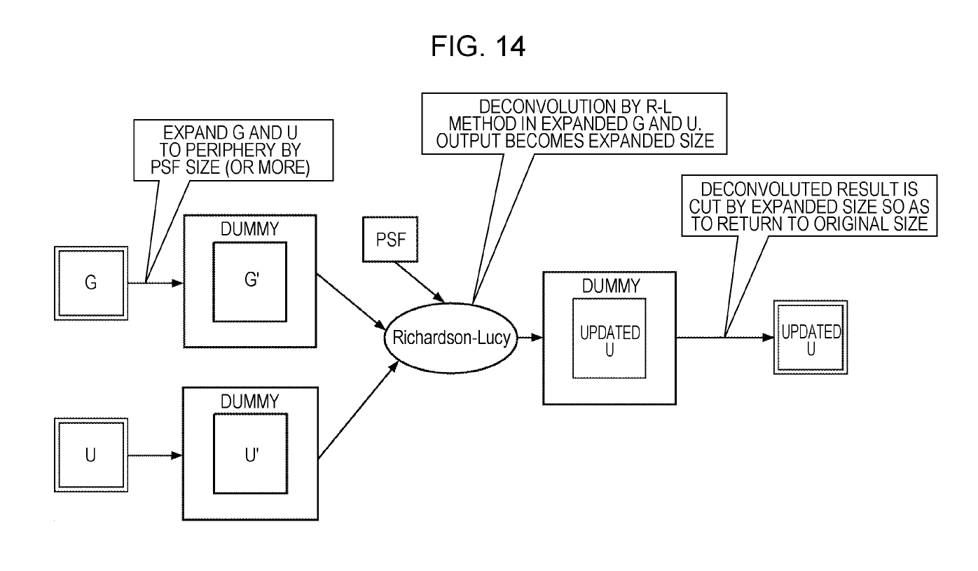

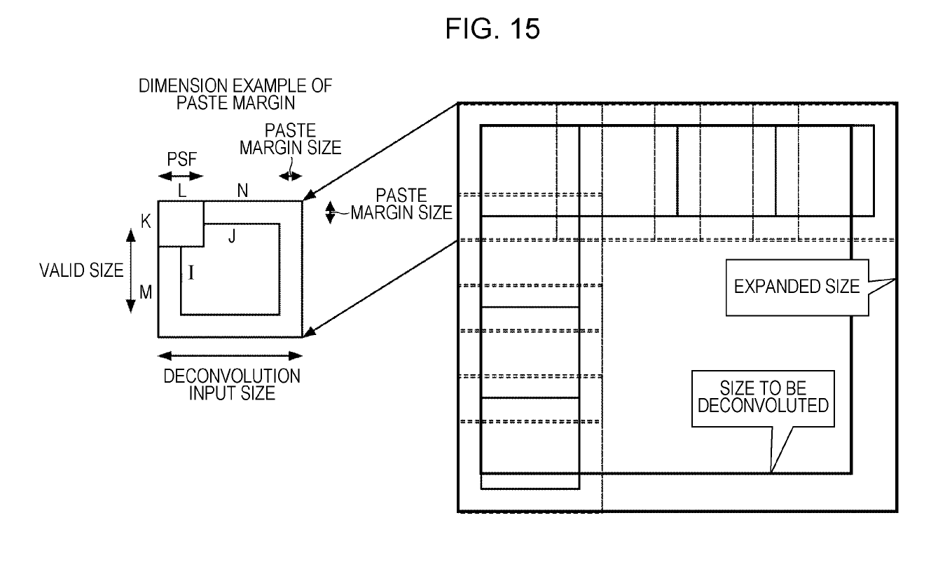

Although, in the first and second embodiments, as described above, the repeated update process may be performed with respect to the blurred image, the present invention is not limited thereto. That is, for example, the blurred image may be divided into a plurality of blocks, the repeated update process may be performed with respect to each block using the information processing device 1 according to the first embodiment or the information processing device 121 according to the second embodiment, the plurality of blocks after the repeated update process may be connected as shown in FIGS. 14 and 15, such that a paste margin process of generating one restored image after restoration is performed.

In detail, although, in the first and second embodiments, the blurred image is divided into the plurality of blocks and the repeated update process is performed with respect to each block, in the paste margin process, after the divided blocks are enlarged (expanded), the repeated update process is performed and the plurality of reduced blocks obtained by reducing the blocks after the repeated update process to the size of the original blocks is connected, thereby generating one restored image after restoration.

FIGS. 14 and 15 show a state of the paste margin process of generating one restored image after restoration by connecting the plurality of blocks after the repeated update process.

Next, a process of generating the structure U^{k} corresponding to each of the plurality of blocks configuring the blurred image will be described with reference to FIG. 14.

As shown in FIG. 14, in order to maintain continuity between neighboring blocks, each of the plurality of blocks (for example, G shown in FIG. 14) configuring the blurred image is enlarged (expanded) to a size for enabling the neighboring blocks to partially overlap each other. In this way, the enlarged block (for example, G′, to which a dummy is added, shown in FIG. 14) is generated.

In addition, the structure U⁰ (for example, U shown in FIG. 14) corresponding to each of the plurality of blocks configuring the blurred image is enlarged to the same size. In this way, the enlarged structure (for example, U′, to which a dummy is added, shown in FIG. 14) is generated.

In addition, the update of the enlarged structure is performed by the Richardson-Lucy method, based on the enlarged block, the enlarged structure and the point spread function H⁰ (for example, PSF shown in FIG. 14) generated based on the enlarged block.

The enlarged structure (for example, an updated U, to which a dummy is added, shown in FIG. 14) after update obtained by the update of the enlarged structure by the Richardson-Lucy method is reduced to the size of the original structure U⁰.

In this way, the structure (for example, the updated U shown in FIG. 14) with continuity hold between neighboring blocks as the structure corresponding to each of the plurality of blocks configuring the blurred image is acquired and the acquired structures are connected as shown in FIG. 15, such that the restored image, from which blur is reduced (eliminated), is acquired.

In one enlarged block, the update of the point spread function H^{k} may be performed, the finally obtained point spread function may be used as the point spread functions of the other enlarged blocks, and the structure U^{k} corresponding to each of the other enlarged blocks may be updated.

In this case, in the other enlarged blocks, the update of the point spread function H^{k} may not be performed and only the update of the structure U^{k} may be performed.

Accordingly, as compared with the case where the update of the corresponding point spread function H^{k}, it is possible to reduce a computation amount for updating (calculating) of the point spread function while reducing (storage capacity of) the memory used to calculate the point spread function H of each of the enlarged blocks.

### Other Modified Example

Although, in the first embodiment, the blurred image is divided into the plurality of blocks and the point spread function H^{k} and the structure U^{k} are repeatedly updated with respect to each block, the update of the point spread function H^{k} may be performed with respect to only predetermined blocks among the plurality of blocks configuring the blurred image and the finally obtained point spread function may be used as the point spread functions of the other blocks, such that it is possible to reduce a computation amount for updating the point spread function while reducing the memory used to calculate the point spread function H^{k} of each of the blocks.

Although, in the repeated update process, the process is performed with respect to the blurred image, the process may be performed with respect to a defocused image in which out-of-focus by a deviation in a focused distance, uniform defocus in plane, peripheral defocus which is in-plane unevenness by a camera lens or the like is generated.

In the repeated update process, the process may be performed with respect to a previously recorded moving image in which blur is generated or the process may be performed by detecting blur generated when a moving image is imaged and eliminating the blur in real time.

Although, in the first embodiment of FIG. 1, the total variation filter 37 is used in order to separate the structure component and the texture component, for example, a bilateral filter or a ε filter may be used.

Although, in the first and second embodiments, the processing unit 28 subtracts the operation result H^{k}OU^{k} from the convolution unit 27 from the blurred image G and supplies the subtracted result G−H^{k}OU^{k} to the residual error generation unit 29, the same result is obtained by dividing the blurred image G by the operation result H^{k}OU^{k} from the convolution unit 27 and supplying the divided result (H^{k}OU^{k})/G to the residual error generation unit 29.

Although, in the above-described repeated update process, the update of the structure U^{k} is performed using the point spread function H^{k} in step S33 and the update of the point spread function H^{k} is performed using the structure U^{k} in step S34, the present invention is not limited thereto.

That is, for example, in the repeated update process, the update of the structure and the update of the point spread function may be alternately performed.

In detail, for example, the update of the structure U^{k} may be performed using the point spread function H^{k} in step S33 and the update of the point spread function H^{k} may be performed using the structure U^{k+1} obtained by the update in step S34. In addition, the update of the structure and the point spread function may be alternated such that the update of the structure U^{k+1} may be performed using the point spread function H^{k+1} in step S33 of the next routine and the update of the point spread function H^{k+1}, that is obtained by update, may be performed using the structure U^{k+2} obtained by the update in step S34 of the next routine.

In this case, for example, as compared with the case where the point spread function H^{k} is updated using the structure U^{k}, since the point spread function H^{k} is updated using the structure U^{k+1} close to the true structure, it is possible to acquire the point spread function H^{k+1} close to the true point spread function as the update result of the point spread function H^{k}.

### Method of Increasing Repeated Update Processing Speed

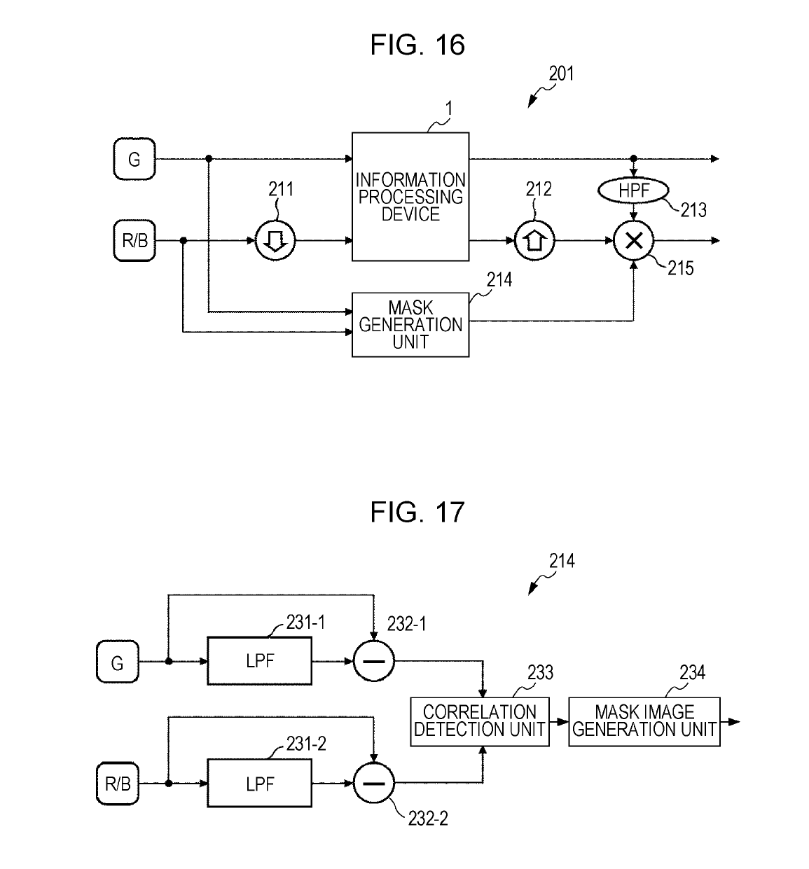

In the above-described repeated update process, it is preferable that a computation amount is reduced as much as possible so as to increase the processing speed. Now, a method of more rapidly correcting blur of an image while suppressing image quality deterioration in the case where the repeated update process is performed with respect to each color component of a red (R) component, a green (G) component and a blue (B) component of a blurred image will be described with reference to FIGS. 16 to 19.

FIG. 16 shows a configuration example of an image processing device 201 which is capable of more rapidly correcting blur of an image while suppressing image quality deterioration in the case where the repeated update process is performed with respect to each color component of an R component, a G component and a B component of a blurred image. The image processing device 201 includes an information processing device 1, a down sample unit 211, an up sample unit 212, a high-pass filter (HPF) 213, a mask generation unit 214, and a multiplying unit 215.

An image (hereinafter, referred to as an R blurred image) including an R component of a blurred image and an image (hereinafter, referred to as a B blurred image) including a B component of the blurred image are input to the down sample unit 211. The down sample unit 211 reduces the R blurred image and the B blurred image at a predetermined magnification and supplies the reduced images (hereinafter, referred to as a reduced R blurred image and a reduced B blurred image) to the information processing device 1.

An image (hereinafter, referred to as a G blurred image) including a G component of the blurred image is input to the information processing device 1, in addition to the reduced R blurred image and the reduced B blurred image. The information processing device 1 performs the repeated update process described above with reference to FIG. 10 with respect to the G blurred image, the reduced R blurred image and the reduced B blurred image and corrects the blur of the structure component of each image. The information processing device 1 supplies an image (hereinafter, referred to as a G corrected image), of which the blur of the structure component of the G blurred image is corrected, to the HPF 213 and externally outputs the image. In addition, the information processing device 1 supplies an image (hereinafter, referred to as a reduced R corrected image), of which the blur of the structure component of the reduced R blurred image is corrected, and an image (hereinafter, referred to as a reduced B corrected image), of which the blur of the structure component of the reduced B blurred image is corrected, to the up sample unit 212.

The up sample unit 212 returns the reduced R corrected image and the reduced B corrected image to a size before reduction and supplies images (hereinafter, referred to as an R corrected image and a B corrected image) obtained as the result to the multiplying unit 215.

The HPF 213 attenuates a frequency component lower than a predetermined threshold of the G corrected image so as to extract a texture component of the G corrected image. The HPF 213 supplies an image (hereinafter, referred to as a G texture image) including the extracted texture component to the multiplying unit 215.

The R blurred image, the G blurred image and the B blurred image are input to the mask generation unit 214. The mask generation unit 214 generates a mask image (hereinafter, referred to as an RG mask image) used when the R corrected image and the G texture image are synthesized in the multiplying unit 215, based on correlation between a variation in pixel value of the R blurred image and a variation in pixel value of the G blurred image. In addition, the mask generation unit 214 generates a mask image (hereinafter, referred to as a BG mask image) used when the B corrected image and the G texture image are synthesized in the multiplying unit 215, based on correlation between a variation in pixel value of the B blurred image and a variation in pixel value of the G blurred image. The mask generation unit 214 supplies the generated RG mask image and BG mask image to the multiplying unit 215.

The multiplying unit 215 synthesizes the G texture image to the R corrected image using the RG mask image. In addition, the multiplying unit 215 synthesizes the G texture image to the B corrected image using the BG mask image. The multiplying unit 215 externally outputs an image (hereinafter, referred to as an R texture synthesized image) obtained by synthesizing the G texture image to the R corrected image and an image (hereinafter, referred to as a B texture synthesized image) obtained by synthesizing the G texture image to the B corrected image.

FIG. 17 shows a configuration example of a function of the mask generation unit 214. The mask generation unit 214 includes low-pass filters (LPFs) 231-1 and 231-2, subtraction units 232-1 and 232-2, a correlation detection unit 233, and a mask image generation unit 234.

The G blurred image is input to the LPF 231-1. The LPF 231-1 attenuates a frequency component higher than a predetermined threshold of the G blurred image and supplies the G blurred image, the high frequency component of which is attenuated, to the subtraction unit 232-1.

The G blurred image before the high frequency component is attenuated is input to the subtraction unit 232-1, in addition to the G blurred image, the high frequency component of which is attenuated by the LPF 231-1. The subtraction unit 232-1 obtains a difference between the G burred images before and after the high frequency component is attenuated so as to extract the high frequency component of the G blurred image. The subtraction unit 232-1 supplies the image (hereinafter, referred to as a G high-frequency blurred image) including the extracted high frequency component of the G blurred image to the correlation detection unit 233.

The R blurred image and the B blurred image are input to the LPF 231-2. The LPF 231-1 attenuates frequency components higher than predetermined thresholds of the R blurred image and the B blurred image and supplies the R blurred image and the B blurred image, the high frequency components of which are attenuated, to the subtraction unit 232-2.

The R blurred image and the B blurred image before the high frequency components are attenuated are input to the subtraction unit 232-2, in addition to the R blurred image and the B blurred image, the high frequency components of which are attenuated by the LPF 231-2. The subtraction unit 232-2 obtains a difference between the R burred images before and after the high frequency component is attenuated so as to extract the high frequency component of the R blurred image, and obtains a difference between the B burred images before and after the high frequency component is attenuated so as to extract the high frequency component of the B blurred image. The subtraction unit 232-2 supplies the image (hereinafter, referred to as an R high-frequency blurred image) including the extracted high frequency component of the R blurred image and the image (hereinafter, referred to as a B high-frequency blurred image) including the extracted high frequency component of the B blurred image to the correlation detection unit 233.

The correlation detection unit 233 detects correlation between the high frequency component of the R blurred image and the high frequency component of the G blurred image and correlation between the high frequency component of the B blurred image and the high frequency component of the G blurred image and supplies the detected results to the mask image generation unit 234.

The mask image generation unit 234 generates an RG mask image based on the correlation between the high frequency component of the R blurred image and the high frequency component of the G blurred image and generates a BG mask image based on the correlation between the high frequency component of the B blurred image and the high frequency component of the G blurred image. The mask image generation unit 234 supplies the generated RG mask image and BG mask image to the multiplying unit 215.

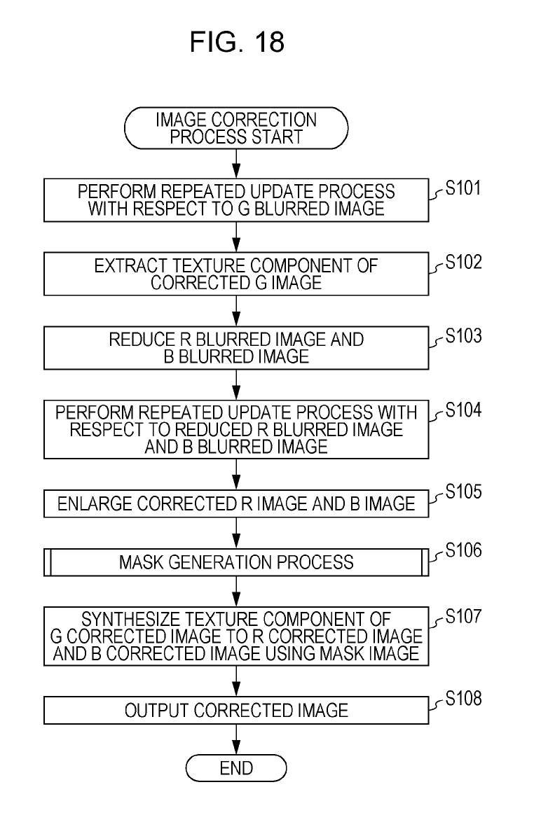

Next, an image correcting process executed by the image processing device 201 will be described with reference to the flowchart of FIG. 18. In addition, this process begins, for example, when a blurred image to be corrected is input to the image processing device 201 and an instruction for executing the image correcting process is started through a manipulation unit (not shown). In addition, a G blurred image including a G component of the input blurred image is supplied to the information processing device 1 and the LPF 231-1 and the subtraction unit 232-1 of the mask generation unit 214 and an R blurred image including an R component of the blurred image and a B blurred image including a B component of the blurred image are supplied to the down sample unit 211 and the LPF 231-2 and the subtraction unit 232-2 of the mask generation unit 214.

In step S101, the information processing device 1 performs the repeated update process described above with reference to FIG. 10 with respect to the G blurred image. The information processing device 1 supplies the G corrected image obtained as the result of the repeated update process to the HPF 213.

In step S102, the HPF 213 extracts the texture component of the corrected G image. That is, the HPF 213 attenuates the frequency component lower than the predetermined threshold of the G corrected image so as to extract the texture component of the G corrected image. The HPF 213 supplies the extracted G texture image including the texture component of the G corrected image to the multiplying unit 215.

In step S103, the down sample unit 211 reduces the R blurred image and the B blurred image at the predetermined magnification. The down sample unit 211 supplies the reduced images, that is, the reduced R blurred image and the reduced B blurred image to the information processing device 1.

In step S104, the information processing device 1 performs the repeated update process with respect to the reduced R blurred image and B blurred image. That is, the information processing device 1 individually performs the repeated update process described above with reference to FIG. 10 with respect to the reduced R blurred image and the reduced B blurred image. The information processing device 1 supplies the reduced R corrected image and the reduced B corrected image obtained as the result of the repeated update process to the up sample unit 212.

In step S105, the up sample unit 212 enlarges the corrected R image and B image. That is, the up sample unit 212 returns the reduced R corrected image and the reduced B corrected image to sizes before reduction. The up sample unit 212 supplies the enlarged images, that is, the R corrected image and the B corrected image to the multiplying unit 215.

In addition, the R corrected image and the B corrected image are images obtained by reducing the original R blurred image and B blurred image, correcting blur, and enlarging the images to original sizes, and a portion of information about the texture component in the original images at the time of reduction is lost. Accordingly, the R corrected image and the B corrected image is corrected for the blur, as compared with the original R blurred image and B blurred image, but become images which lack texture components.

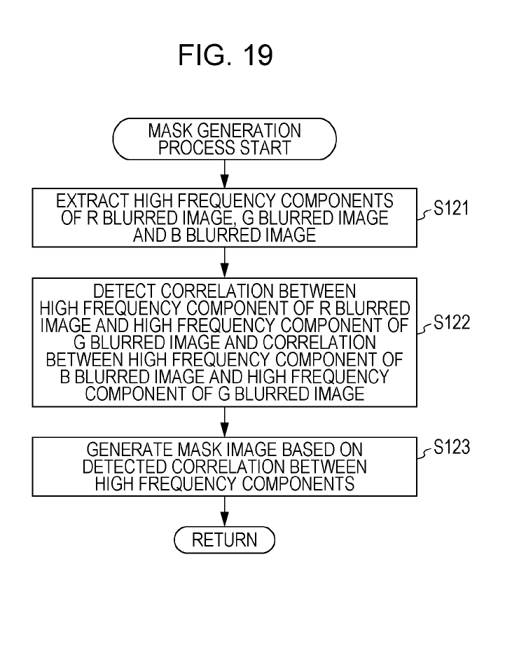

In step S106, the mask generation unit 214 executes the mask generation process. Now, the details of the mask generation process will be described with reference to the flowchart of FIG. 19.

In step S121, the mask generation unit 214 extracts the high frequency components of the R blurred image, the G blurred image and the B blurred image. In detail, the LPF 231-1 attenuates a frequency component higher than a predetermined threshold of the G blurred image and supplies the G blurred image, the high frequency component of which is attenuated, to the subtraction unit 232-1. The subtraction unit 232-1 obtains a difference between the G burred images before the high frequency component is attenuated and the G blurred image after the high frequency component is attenuated by the LPF 231-1 so as to extract the high frequency component of the G blurred image. The subtraction unit 232-1 supplies the G high-frequency blurred image including the extracted high frequency component of the G blurred image to the correlation detection unit 233.

The LPF 231-2 attenuates a frequency component higher than a predetermined threshold of the R blurred image and supplies the R blurred image, the high frequency component of which is attenuated, to the subtraction unit 232-2. The subtraction unit 232-2 obtains a difference between the R burred images before the high frequency component is attenuated and the R blurred image after the high frequency component is attenuated by the LPF 231-2 so as to extract the high frequency component of the R blurred image. The subtraction unit 232-2 supplies the R high-frequency blurred image including the extracted high frequency component of the R blurred image to the correlation detection unit 233.

Similarly, the LPF 231-2 attenuates a frequency component higher than a predetermined threshold of the B blurred image and supplies the B blurred image, the high frequency component of which is attenuated, to the subtraction unit 232-2. The subtraction unit 232-2 obtains a difference between the B burred images before the high frequency component is attenuated and the B blurred image after the high frequency component is attenuated by the LPF 231-2 so as to extract the high frequency component of the B blurred image. The subtraction unit 232-2 supplies the B high-frequency blurred image including the extracted high frequency component of the B blurred image to the correlation detection unit 233.

In step S122, the correlation detection unit 233 detects correlation between the high frequency component of the R blurred image and the high frequency component of the G blurred image and correlation between the high frequency component of the B blurred image and the high frequency component of the G blurred image. In detail, the correlation detection unit 233 obtains a difference between the R high-frequency blurred image and the G high-frequency blurred image and detects the correlation between the high frequency component of the R blurred image and the high frequency component of the G blurred image. That is, the correlation detection unit 233 obtains the difference between the R high-frequency blurred image and the G high-frequency blurred image so as to generate an image (hereinafter, referred to as an RG high-frequency difference image) indicating the correlation between the high frequency component of the R blurred image and the high frequency component of the G blurred image. In the RG high-frequency difference image, the pixel value is decreased for a region in which the correlation between the high frequency component of the R blurred image and the high frequency component of the G blurred image is strong and is increased for a region in which the correlation is weak.

Similarly, the correlation detection unit 233 obtains a difference between the B high-frequency blurred image and the G high-frequency blurred image so as to generate an image (hereinafter, referred to as a BG high-frequency difference image) indicating the correlation between the high frequency component of the B blurred image and the high frequency component of the G blurred image. The correlation detection unit 233 supplies the generated RG high-frequency difference image and BG high-frequency difference image to the mask image generation unit 234.

In step S123, the mask image generation unit 234 generates a mask image based on the detected correlation between the high frequency components. In detail, the mask image generation unit 234 generates the RG mask image in which the pixel value is decreased for a pixel with a larger pixel value of the RG high-frequency difference image and is increased for a pixel with a smaller pixel value of the RG high-frequency difference image and the pixel value is normalized in a range of 0 to 1. That is, the pixel value of each pixel of the RG mask image is increased for the pixel in the region in which the correlation between the high frequency component of the R blurred image and the high frequency component of the G blurred image is strong and is decreased for the pixel in the region in which the correlation is weak, within the range of 0 to 1. Similarly, the mask image generation unit 234 generates the BG mask image in which the pixel value is decreased for a pixel with a larger pixel value of the BG high-frequency difference image and is increased for a pixel with a smaller pixel value of the BG high-frequency difference image and the pixel value is normalized in a range of 0 to 1. The mask image generation unit 234 supplies the generated RG mask image and BG mask image to the multiplying unit 215.

Thereafter, the mask generation process is finished.

Returning to FIG. 18, in step S107, the multiplying unit 215 synthesizes the texture component of the G corrected image to the R corrected image and the B corrected image using a mask image. That is, the multiplying unit 215 multiplies the R corrected image by the G texture image using the RG mask image so as to restore the texture component of the R corrected image lost at the time of reduction. Similarly, the multiplying unit 215 multiplies the B corrected image by the G texture image using the BG mask image so as to restore the texture component of the B corrected image lost at the time of reduction.

At this time, by using the RG mask image, correlation between the variation of the R component and the variation of the G component in the blurred image is weak for a region in which the correlation between the high frequency component of the R blurred image and the high frequency component of the G blurred image is weak, and the synthesis amount of the texture component of the G corrected image to the R corrected image is decreased. In contrast, correlation between the variation of the R component and the variation of the G component in the blurred image is strong for a region in which the correlation between the high frequency component of the R blurred image and the high frequency component of the G blurred image is strong, and the synthesis amount of the texture component of the G corrected image to the R corrected image is increased. Similarly, by using the BG mask image, correlation between the variation of the B component and the variation of the G component in the blurred image is weak for a region in which the correlation between the high frequency component of the B blurred image and the high frequency component of the G blurred image is weak, and the synthesis amount of the texture component of the G corrected image to the B corrected image is decreased. In contrast, correlation between the variation of the B component and the variation of the G component in the blurred image is strong for a region in which the correlation between the high frequency component of the B blurred image and the high frequency component of the G blurred image is strong, and the synthesis amount of the texture component of the G corrected image to the B corrected image is increased.

In step S108, the image processing device 201 outputs the corrected image. That is, the information processing device 1 outputs the G corrected image obtained by the process of step S101 to a next-stage device of the image processing device 201, and the multiplying unit 215 outputs the R texture synthesized image and the R texture synthesized image obtained by the process of step S107 to a next-stage device of the image processing device 201. Thereafter, the image correction process is finished.

In this way, by reducing the R blurred image and the B blurred image and then performing the repeated update process, it is possible to reduce a computation amount and increase a processing speed.

In addition, by performing the process without reducing the G blurred image including the G component, to which human eyes are most prone to react, and restoring the texture component lost by reducing the R blurred image and the B blurred image using the texture component of the G blurred image, it is possible to suppress image quality deterioration due to the increase of the processing speed.

In addition, in the region in which the correlation between the variation of the R component and the variation of the G component is weak and the region in which the correlation between the variation of the B component and the variation of the G component is weak in the blurred image, the synthesis amount of the texture component of the G corrected image is reduced or synthesis is not performed such that it is possible to suppress the generation of a color (pseudo-color) which is not present in an original subject in the image which has been synthesized.

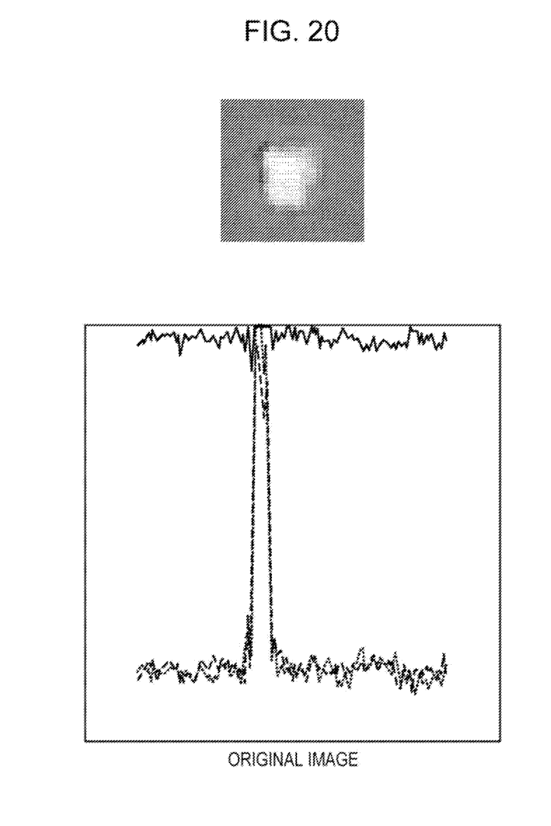

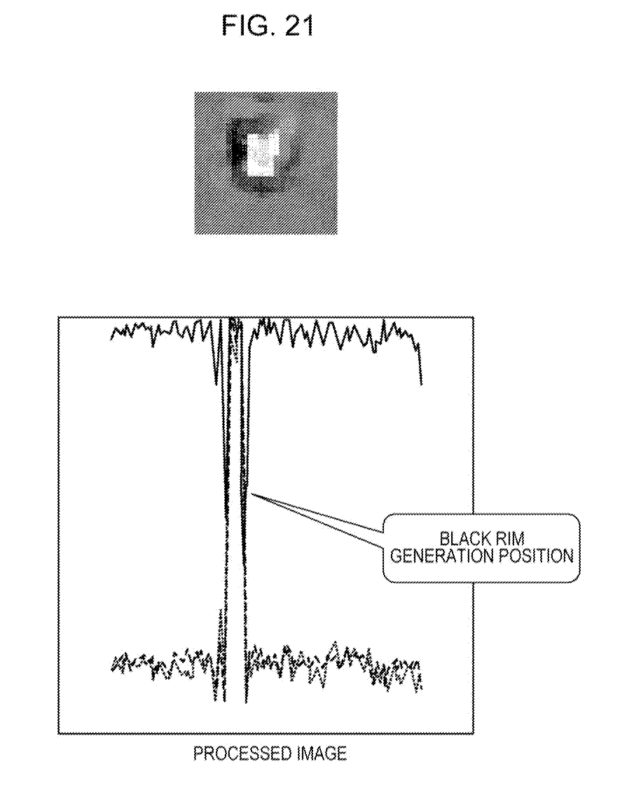

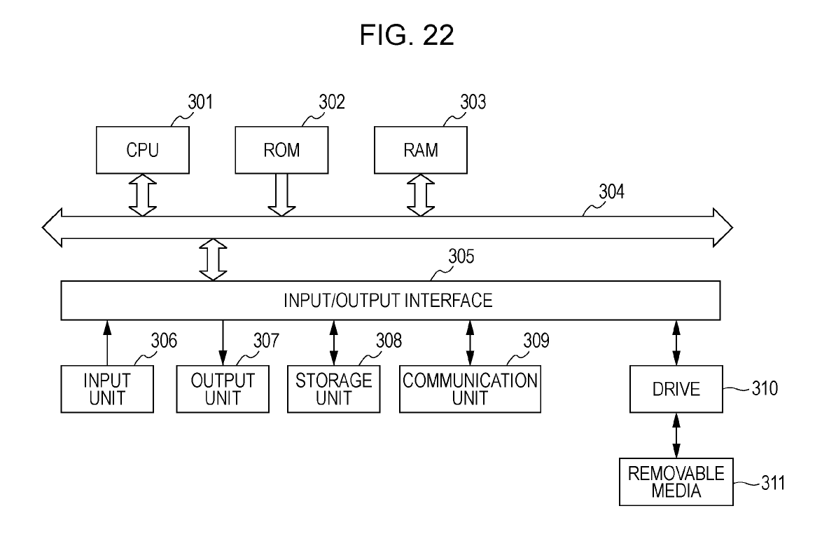

Now, the detailed example of the generation of the pseudo-color will be described with respect to FIGS. 20 and 21.

The upper diagram of FIG. 20 is an enlarged monochromatic diagram of a portion of an image before the image correction process of FIG. 18 is performed. In an actual image, a dark portion of the image has a bright red and a bright portion in a vicinity of the center thereof is brightly lit by reflected light. In addition, the lower graph of FIG. 20 shows the variation of the R component, G component and B component of a line of a horizontal direction in vicinity of the center of the upper image, a solid line denotes the variation of the R component, a fine dotted line denotes the variation of the G component, and a coarse dotted line denotes the variation of the B component. As can be seen from this graph, in the R component, correlation with another component is weak and is not varied to a large value, and, in the G component and the B component, the value is increased in a portion lit by the reflected light and is decreased in the other portion.

Meanwhile, the upper diagram of FIG. 21 shows the result of performing the image correction process of FIG. 18 without using the mask image with respect to the upper diagram of FIG. 20. In addition, the lower graph of FIG. 21 is the same graph as the lower graph of FIG. 20 and shows the variation of the R component, the G component and the B component of the line of the same horizontal direction as the lower graph of FIG. 20 of the upper image. When the graph of FIG. 20 and the graph of FIG. 21 are compared, in the graph of FIG. 21, the value of the R component falls in a portion in which the value of the G component in the vicinity of the boundary of the portion lit by the reflected light varies greatly. In addition, when the upper diagram of FIG. 20 and the upper diagram of FIG. 21 are compared, in the upper diagram of FIG. 21, a pseudo-color is generated in the vicinity of the boundary of the portion lit by the reflected light and a black rim appears. This is caused by synthesizing the texture component of the G corrected image to the R corrected image in the region in which the correlation between the R component and the G component is weak.

As described above, by synthesizing the texture component to the G corrected image to the R corrected image and the B corrected image using the mask image, it is possible to suppress generation of a pseudo-color such as a black rim.

In addition, in the image processing device 201, instead of the information processing device 1, the information processing device 121 of FIG. 13 may be applied.

In addition, for example, although, in the above description, different mask images are used when the texture component of the G corrected image is synthesized to the R corrected image and the texture component of the G corrected image is synthesized to the B corrected image, the same mask image may be used. In this case, for example, a mask image in which the pixel value is decreased for a region in which at least one of the correlation between the high frequency component of the R blurred image and the high frequency component of the G blurred image and the correlation between the high frequency component of the B blurred image and the high frequency component of the G blurred image is weak and is increased for a region in which both the correlations are strong may be generated and used. In other words, for example, the mask image in which the synthesis amount of the structure component of the G corrected image is decreased for the region in which at least one of the correlation between the variation of the G blurred image and the variation of the R blurred image or the correlation between the variation of the B component and the variation of the G component is weak and is increased for the region in which both the correlations are strong may be generated and used.

In addition, although the example of correcting the blurred image is described in the above description, the present invention is applicable to the case of correcting an image in which defocus is generated by out-of-focus or the like or an image in which both blur and defocus are generated.

The information processing device 1 according to the first embodiment and the information processing device 121 according to the second embodiment, for example, is applicable to a recording/reproducing device capable of reproducing or recording an image.

### Configuration Example of Computer

However, the above-described series of processes may be executed by dedicated hardware or software. If the series of processes is executed by software, a program configuring the software is installed from a program storage medium in a so-called embedded computer, for example, a general-purpose personal computer capable of executing various functions by installing various programs.

FIG. 20 shows a configuration example of a computer for executing the above-described series of processes by a program.

A Central Processing Unit (CPU) 301 executes various processes according to the program stored in a Read Only Memory (ROM) 302 or a storage unit 308. In a Random Access Memory (RAM) 303, a program, data or the like executed by the CPU 301 is appropriately stored. The CPU 301, the ROM 302 and the RAM 303 are connected to each other by a bus 304.

An input/output interface 305 is connected to the CPU 301 through the bus 304. An input unit 306 including a keyboard, a mouse, and a microphone and an output unit 307 including a display and a speaker are connected to the input/output interface 305. The CPU 301 executes various processes in correspondence with an instruction input from the input unit 306. In addition, the CPU 301 outputs the processed result to the output unit 307.

The storage unit 308 connected to the input/output interface 305 includes a hard disk, and stores the program executed by the CPU 301 or a variety of data. A communication unit 309 communicates with an external device over a network such as the Internet or a local area network.

In addition, the program may be acquired through the communication unit 309 and may be stored in the storage unit 308.

When removable media 311 such as a magnetic disk, an optical disc, a magnetooptical disc and a semiconductor memory are mounted, a drive 310 connected to the input/output interface 305 drives it and acquires a program, data or the like recorded thereon. The acquired program or data is transmitted to and stored in the storage unit 308 as necessary.

A program storage medium which is installed in a computer so as to store a program executable by the computer includes removable media 311 which are package media, such as a magnetic disk (including a flexible disk), an optical disc (including a Compact Disc-Read Only Memory (CD-ROM) and a Digital Versatile Disc (DVD)), a magnetooptical disc (including Mini-disc (MD)) and a semiconductor memory, or a hard disk configuring a ROM 302 or the storage unit 308 for temporarily or permanently storing a program. As shown FIG. 20 The storage of the program in the program storage medium is performed using a wired or wireless communication medium such as a local area network, the Internet or a digital satellite broadcast through the communication unit 309 which is an interface such as a router or a modem, as necessary.

In addition, in the present specification, the step of describing the program stored in the program storage medium may be performed in time sequence during the described sequence or may be performed in parallel or individually without being performed in time sequence.

The embodiments of the present invention are limited to the above-described embodiments and various modifications may be made without departing from the scope of the present invention.

The present application contains subject matter related to that disclosed in Japanese Priority Patent Application JP 2009-294544 filed in the Japan Patent Office on Dec. 25, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing device comprising:
a texture extraction unit extracting a texture component of a G corrected image in which blur or defocus of a structure component of a G image including a G component of an input image is corrected;
a mask generation unit generating a mask image in which the synthesis amount of the texture component of the G corrected image to an R corrected image returning to a size before reduction after correcting blur or defocus of a structure component of an image obtained by reducing an R image including an R component of the input image and a B corrected image returning to a size before reduction after correcting blur or defocus of a structure component of an image obtained by reducing a B image including a B component of the input image is decreased for a region in which at least one of correlation between a variation of the G component of the input image and a variation of the R component of the input image or correlation between the variation of the G component of the input image and a variation of the B component of the input image is weak; and
a synthesis unit synthesizing the texture component of the G corrected image to the R corrected image and the B corrected image using the mask image.

2. The image processing device according to claim 1, wherein the mask generation unit generates a first mask image in which the synthesis amount of the texture component of the G corrected image to the R corrected image is decreased for a region in which correlation between a high frequency component of the R image and a high frequency component of the G image is weak, generates a second mask image in which the synthesis amount of the texture component of the G corrected image to the B corrected image is decreased for a region in which correlation between a high frequency component of the B image and the high frequency component of the G image is weak, the synthesize unit synthesizes the texture component of the G corrected image to the R corrected image using the first mask image, and synthesizes the texture component of the G corrected image to the B corrected image using the second mask image.

3. The image processing device according to claim 2, wherein the mask generation unit includes:
a high frequency extraction unit extracting high frequency components of the R image, the G image and the B image;
a detection unit detecting a difference between the high frequency component of the R image and the high frequency component of the G image and a difference between the high frequency component of the B image and the high frequency component of the G image; and
a generation unit generating the first mask image in which the synthesis amount of the texture component of the G corrected image to the R corrected image is decreased for the region in which the difference between the high frequency component of the R image and the high frequency component of the G image is large and to generate the second mask image in which the synthesis amount of the texture component of the G corrected image to the B corrected image is decreased for the region in which the difference between the high frequency component of the B image and the high frequency component of the G image is large.

4. The image processing device according to claim 1, further comprising:
a reduction unit reducing the R image and the B image;
a correction unit correcting the blur or defocus of the structure component of an R reduced image obtained by reducing the R image, the structure component of a B reduced image obtained by reducing the B image, and the structure component of the G image; and
an enlargement unit returning the R reduced image and the B reduced image after the blur or defocus is corrected to an original size.

5. An image processing method comprising the steps of: at an image processing device,
extracting a texture component of a G corrected image in which blur or defocus of a structure component of a G image including a G component of an input image is corrected;
generating a mask image in which the synthesis amount of the texture component of the G corrected image to an R corrected image returning to a size before reduction after correcting blur or defocus of a structure component of an image obtained by reducing an R image including an R component of the input image and a B corrected image returning to a size before reduction after correcting blur or defocus of a structure component of an image obtained by reducing a B image including a B component of the input image is decreased for a region in which at least one of correlation between a variation of the G component of the input image and a variation of the R component or correlation between the variation of the G component of the input image and a variation of the B component is weak; and
synthesizing the texture component of the G corrected image to the R corrected image and the B corrected image using the mask image.

6. A program for executing, on a computer, a process including the steps of:
extracting a texture component of a G corrected image in which blur or defocus of a structure component of a G image including a G component of an input image is corrected;
generating a mask image in which the synthesis amount of the texture component of the G corrected image to an R corrected image returning to a size before reduction after correcting blur or defocus of a structure component of an image obtained by reducing an R image including an R component of the input image and a B corrected image returning to a size before reduction after correcting blur or defocus of a structure component of an image obtained by reducing a B image including a B component of the input image is decreased for a region in which at least one of correlation between a variation of the G component of the input image and a variation of the R component or correlation between the variation of the G component of the input image and a variation of the B component is weak; and
synthesizing the texture component of the G corrected image to the R corrected image and the B corrected image using the mask image.

7. A recording medium having recorded thereon a program for executing, on a computer, a process including the steps of:
extracting a texture component of a G corrected image in which blur or defocus of a structure component of a G image including a G component of an input image is corrected;
generating a mask image in which the synthesis amount of the texture component of the G corrected image to an R corrected image returning to a size before reduction after correcting blur or defocus of a structure component of an image obtained by reducing an R image including an R component of the input image and a B corrected image returning to a size before reduction after correcting blur or defocus of a structure component of an image obtained by reducing a B image including a B component of the input image is decreased for a region in which at least one of correlation between a variation of the G component of the input image and a variation of the R component or correlation between the variation of the G component of the input image and a variation of the B component is weak; and
synthesizing the texture component of the G corrected image to the R corrected image and the B corrected image using the mask image.
